(19) United States
(12) Patent Application Publication
(10) Pub. No.: US 2025/0186183 A1
(43) Pub. Date: Jun. 12, 2025

(54) STORAGE CASES FOR DENTAL APPLIANCES

(71) Applicant: Align Technology, Inc., San Jose, CA (US)

(72) Inventors: Ankit SHUKLA, San Jose, CA (US); Fred TING, San Jose, CA (US); Ken WU, San Jose, CA (US); Eric YAU, Santa Clara, CA (US); Avi KOPELMAN, Palo Alto, CA (US)

(21) Appl. No.: 18/979,580

(22) Filed: Dec. 12, 2024

Related U.S. Application Data
(60) Provisional application No. 63/609,156, filed on Dec. 12, 2023.

(51) Int. Cl. A61C 19/02; B65D 8/00

(52) U.S. Cl. CPC A61C 19/02; B65D 11/02

(57) ABSTRACT

A storage case for dental appliances can include a lid and a base that form an enclosed cavity to receive the dental appliance. The storage case can include a hinge to couple the lid to the base and hold the lid in partially opened and opened predetermined positions with respect to the base. In some variations, the storage case may include one or more drainage holes to facilitate the removal of liquids from within the storage case. The storage cases may also include tactile feedback indicating that the lid is opening and/or closing.

### CLAIM OF PRIORITY

This patent application claims priority to U.S. Provisional Patent Application No. 63/609,156, titled “STORAGE CASES FOR DENTAL APPLIANCES,” filed on Dec. 12, 2023, and herein incorporated by reference in its entirety.

### INCORPORATION BY REFERENCE

All publications and patent applications mentioned in this specification are herein incorporated by reference in their entirety to the same extent as if each individual publication or patent application was specifically and individually indicated to be incorporated by reference.

### FIELD

This disclosure relates generally to dental appliances, and more specifically to storage cases for dental appliances.

### BACKGROUND

Dental appliances, such as dental aligners, retainers, mouthguards, and the like are commonly used to treat a variety of dental conditions. Oftentimes, however, the dental appliance is not worn continuously. For example, some dental appliances are removed for eating or cleaning. Still other dental appliances are worn only at night or other limited times. Existing storing cases for dental appliances may be difficult or inconvenient to use, e.g., requiring more than one hand to operate, and may open when dropped, and may collect debris and fluid.

Thus, there exists a need for a storage container that can safely house and protect the dental appliances, while being secure, safe and easy to operate. The dental appliance storage cases described herein may address these needs.

### SUMMARY OF THE DISCLOSURE

Described herein are various storage cases for dental appliances. Generally, the storage cases may enclose and protect a dental appliance. The dental appliance to be protected may be any appropriate dental appliance, including, but not limited to, an aligner, palatal expander, etc. The storage cases described herein may include a body, having a base including one or more storage cavities, and a lid that is movably connected to the body to transition from a closed configuration, in which the lid covers the opening into the base and the one or more storage cavities, and one or more open configurations.

In general, the dental appliance storage devices described herein may be storage cases for storing one or more (e.g., a pair of) dental appliances, including but not limited to dental aligners, palatal expanders, etc. These storage cases may include one or more features to improve the operation and use of the dental appliance. For example, the dental appliance storage cases described herein may have a lid that is hinged and configured so that it stays open and does not close on its own in a predetermined fully open position and/or a predetermined partially open position (even under the weight of the lid). When closed, the lid stays closed even when dropped, to protect and retain the internal contents within the storage case. Any of these dental appliance storage cases may have a predetermined partially open position to allow insertion of one or more dental appliances into the case while making it more difficult for an appliance already in the case to fall out. They may also have a predetermined fully open position, exposing more of inner volume of the case. In some examples the hinge region may be configured with one or more biases so that a user must apply a force against the one or more biases to open the lid of the case from a fully closed configuration part way to the stable partially open position (e.g., to a first transition position), after which the one or more biases may drive the lid to self-open from the first transition position to the predetermined partially open position. From the predetermined partially open position, the lid may be fully opened by applying force against the one or more biases tending to keep the lid in the predetermined partially open position, until part way to the predetermined fully open position (e.g., to a second transition position), after which the one or more biases may drive the lid to self-open from the second transition position to the predetermined fully open position.

The lid may be re-closed from the stable fully open position by pushing against the one or more biases until reaching the second transition position, to overcome the bias force tending to transition the lid to the predetermined fully open position. Once the lid is closed past the second transition point, the one or more biases tend to self-close the lid to the predetermined partially open position. The lid may be closed from the stable partially open position by applying force against the one or more biases tending to open the lid from the first transition position to the stable partially open position. The one or more biases may then tend to self-close the lid from the first transition position to the fully closed position.

The predetermined fully open position may be, e.g., with the lid opened 50 degrees or greater relative to the angle of the lid from the fully closed position to the predetermined fully open position (e.g., 55 degrees or greater, 60 degrees or greater, 65 degrees or greater, 70 degrees or greater, 75 degrees or greater, 80 degrees or greater, 85 degrees or greater, 90 degrees or greater, 95 degrees or greater, 100 degrees or greater, 105 degrees or greater, 110 degrees or greater, 115 degrees or greater, 120 degrees or greater, 125 degrees or greater, 130 degrees or greater, 135 degrees or greater, 140 degrees or greater, 145 degrees or greater, 150 degrees or greater, 155 degrees or greater, 160 degrees or greater, etc. including 70-180 degrees, 80-180 degrees, 90-180 degrees, etc.) In general, the predetermined positions for the fully open position and the partially open position may be pre-set and may be stable, so that the lid may be maintained in these particular positions without the application of additional force. Due to hysteresis and stiction the absolute position of the lid in the predetermined fully opened and partially open positions may vary by, e.g., +/−2% (e.g., +/−3%, +/−5%, +/−7%, +/−9%, +/−10%, +/−12%, +/−15%, etc.).

In general, the predetermined fully opened and partially open positions may be determined as angles of the lid relative to the closed (fully closed) position of the lid. For example, in the fully closed position of the lid, the angle of the lid may be referred to as 0 degrees. The position of the lid may also be described as relative to the body of the device.

The predetermined partially open position may be, e.g., between about 10 degrees and about 90 degrees relative to the body of the case (e.g., between about 15 degrees and about 85 degrees, between about 20 degrees and about 80 degrees, between about 25 degrees and about 45 degrees, between about 30 degrees and about 45 degrees, between about 20 degrees and about 40 degrees, between about 50 and 90 degrees, between about 60 and 85 degrees, between about 70 and 85 degrees, etc.). In some examples the predetermined partially open position is approximately halfway between the closed position (closed configuration) and the predetermined fully open position (e.g., between about 25%-55%, between about 30%-55%, between about 35-60%, between about 40-65%, etc. of the angle between the closed position and the predetermined fully open position). In some examples the predetermined partially open position is approximately two-thirds between the closed position and the predetermined fully open position (e.g., between about 50%-85%, between about 55%-75%, etc.).

The first transition position may be about halfway between the closed position of the lid and the predetermined partially open position of the lid. For example, the first transition position may be between about 40%-60% of the angle between the closed position of the lid and the predetermined partially open position of the lid (e.g., between about 45%-65%, between about 50-70%, between about 30-50%, between about 35%-55%, etc. of the way between the closed position and the predetermined partially open position). The second transition position may be about halfway between the predetermined partially open position of the lid and the predetermined fully open position of the lid. For example, the second transition position may be between about 40%-60% of the angle between the predetermined partially open position of the lid and the predetermined fully open position of the lid (e.g., between about 45%-65%, between about 50-70%, between about 30-50%, between about 35%-55%, etc. of the way between the predetermined partially open position and the predetermined fully open position).

The one or more biases may be one or more springs, one or more mechanical linkages (e.g., cam surface and cam follower), or any combination of these. The one or more biases may be configured to apply a force to prevent opening of the lid from the closed position to the first transition position, or to self-close the lid from the first transition position to the closed position, that is constant, increasing or decreasing. The one or more biases may be configured to apply a force to self-opening of the lid from the first transition position to the predetermined partially open position, or to prevent closing of the lid from the predetermined partially open position to the first transition position, that is constant, increasing or decreasing. The one or more biases may be configured to apply a force to prevent further opening of the lid from the predetermined partially open position to the second transition position, or to self-close the lid from the second transition position to the predetermined partially open position, that is constant, increasing or decreasing. The one or more biases may be configured to apply a force to self-open the lid from the second transition position to the predetermined fully open position, or to prevent closing of the lid from the predetermined fully open position to the second transition position, that is constant, increasing or decreasing.

The one or more biases may be part of the hinge and/or lid. In general, the one or more biases may be configured so that the force(s) applied to self-open or self-close the lid are sufficient to overcome the weight of the lid. The lid may be a clamshell-type lid.

In any of these examples the dental appliance storage device may include one or more features to assist in identifying the orientation of the case by touch, such as one or more tactile features (e.g. protrusions) that may permit a user to distinguish between the top and bottom of the dental appliance storage device, the front and back of the dental appliance storage device, and/or the location of the hinge region.

The appliance storage devices described herein may be partitioned into one or more compartments and/or regions that may be configured to hold different dental appliances, such as upper arch appliances and lower arch appliances, and/or appliances for different stages of a treatment plan. In some examples each compartment or region may including one or more holders for holding the different appliances, and may be marked by a visual and/or tactile marking corresponding to the dental appliance to be retained in the different compartments or regions. The compartments may be isolated from each other (e.g., separated from each other by one or more walls) or may be partially open or fully open. For example, in some appliance storage devices a single compartment may include multiple regions for storing different appliances. The holder(s) may be configured to mate with the dental appliances to be held. A holder may include one or more posts, recesses or the like, including tooth-shaped projections or recesses configured to hold the dental appliance(s). In some examples the holders may include a securement, such as a clip, a clamp or the like, to secure the appliance to the holder.

Any of the storage cases described herein may include one or more drainage holes to allow the drainage of any liquids within the storage case. For example, water from rinsing a dental appliance can easily drain through any of the drainage holes. Draining fluid (e.g., water, saliva, etc.) may advantageously resist or prevent mold or mildew from forming on the dental appliance.

For example, described herein are storage cases for a dental appliance that include: a lid; a base having an open cavity configured to receive the dental appliance, wherein the base and the lid are operable to form an enclosed cavity between the lid and the base to enclose the dental appliance; and a hinge comprising one or more biases, wherein the one or more biases is configured to provide a resistance to opening the lid from a closed position to a first transition position that is part way to a predetermined partially open position, further wherein the one or more biases is configured to apply a force to open the lid from the first transition position to the predetermined partially open position, further wherein the one or more biases is configured to provide a resistance to opening the lid from the predetermined partially open position to a second transition position, and further wherein the one or more biases is configured to apply a force to opens the lid from the second transition position to a predetermined fully open position.

The predetermined partially open position may be between 25% and 55% of the angle between the closed position and the predetermined fully open position. The predetermined partially open position may be between 10-60 degrees relative to the closed position. The predetermined fully open position may be between 90-180 degrees relative to the closed position. The first transition position may be between about 40-60% of the angle between the closed position of the lid and the predetermined partially open position of the lid. The second transition position may be between about 40-60% of the angle between the predetermined partially open position of the lid and the predetermined fully open position of the lid.

The one or more biases may comprise a cam (e.g., cam surface and/or cam follower) and/or a spring. The one or more biases may be part of the hinge, part of the lid or part of the hinge and the lid. For example, the one or more biases may include a spring configured to apply a force to the lid to hold the lid away from the base or closed against the base. The cam may comprise a cam surface having a cam profile configured to receive the force from a spring to hold the lid away from the base in the predetermined partially open position, and/or to hold the lid away from the base in the predetermined and/or to hold the lid closed against the base. In some examples the cam profile is integrally formed with the lid. The spring may comprise: a flat spring, a wire spring, or a combination thereof. The spring may be configured to follow the cam profile.

In any of these examples the open cavity of the base may include a raised pattern configured to elevate the dental appliance away from a floor of the open cavity. The base may include one or more drainage holes on a floor of the open cavity configured to allow liquids to drain from the storage case.

Thus, any of the storage cases described herein may be configured to improve drainage from out of the storage case, so that fluid (e.g., saliva, water, cleaning solution, etc.) is drained, wicked, or otherwise removed from the chamber of the case and therefore away from any dental appliances held within the case. In particular, one or more (or all of the) drains may be positioned at or near the hinge region. The base of the case, on or beneath the surface that the dental appliance sits, may be titled at an angle towards the hinge region (e.g., the base plane of the case may be at an angle with a level ground surface on which the case rests). In any of these cases, the base may include a raised (e.g., embossed) surface that is configured to guide fluid towards the drain feature when the storage case is resting on a flat surface.

For example, a storage case may include: a lid; and a base having an open cavity configured to receive a dental appliance, wherein the base and the lid are operably coupled together at a hinge to be form an enclosed cavity between the lid and the base to enclose the dental appliance, further wherein the base includes one or more drainage holes on or adjacent to the hinge region that are configured to drain liquids from inside the base to outside the base, further wherein the based in configured so that the open cavity is titled towards the one or more drainage holes when the base is seated on a horizontal surface.

The one or more drainage holes may be concurrently disposed on a floor and a wall of the base. The one or more drainage holes may be disposed on a floor of the base. The base may include one or more channels configured to collect and direct liquid toward the one or more drainage holes. The one or more channels may be shaped in an undulating, curving (e.g., wavy) pattern. In some examples the base includes one or more feet disposed on an outer surface of the base configured to tilt a floor of the base toward the one or more drain holes. The lid and the base may be formed in any appropriate manner, including (but not limited to) from an injection molding (e.g., of plastic). For example the storage case may be formed of an injected molded plastic such as Vesaflex-OM3060.

In any of these examples, the base may include a liner formed from a hydrophobic material. The case may include a reservoir configured to collect fluids from the one or more drainage holes.

Any of the storage cases described herein may include a compartment in fluid communication with the open cavity that is configured to hold an odor reducing/preventing composition.

Also described herein are dental appliance storage cases that can be opened and closed, e.g., by a twisting action. In particular, any of these cases may be formed of a very small number (e.g., just 2 or 3) parts that may be injection molded, e.g., of recyclable plastic PET. The twisting and closing action may be made possible by a threaded male and female feature at the center of the bottom and top half of the case. The bottom half may have a holding feature to help in the twist/screw action. Since the top and bottom halves may close together completely, the aligners may be held securely in the case and prevented from falling out even if the case falls on the ground; the case typically does not open on such impact.

For example, a storage case may include: a lid comprising: a first housing section; sides extending from an outer perimeter of the first housing section; and a first portion of a separable threaded joint centrally disposed of the first housing section; and a base comprising: a second housing section; sides extending from an outer perimeter of the second housing section; and a second portion of the separable threaded joint centrally disposed on the second housing, wherein the lid and the base are configured to couple together by the separable threaded joint to form an enclosed cavity to hold one or more dental appliances.

In some examples enclosed cavity may be formed of only the lid and the base. The first portion of the separable threaded joint may include an opening configured to receive a shaft of the second portion of the separable threaded joint. The opening may include a flared section larger than the shaft. The shaft may include a tapered section that is narrower than the opening. In some examples the base includes one or more drainage holes. In some examples the base includes one or more finger grips. The lid and the base may be recyclable and/or formed of a recycled material (e.g., polyethylene terephthalate, PET).

In any of these examples the separable threaded joint may be configured to releasably lock the lid and the base together to form the enclosed cavity.

Any of the storage cases described herein may be configured to be easy to open with just one single hand. In any of the storage cases described herein, the case may be configured so that it does not open when dropped (e.g., when falling and striking the ground), which may be problematic for existing, including traditional clamshell-type, storage cases. In some example, the storage cases described herein may also or alternatively be configured to comfortably hold more than one dental appliance and/or hold a dental appliance in a smaller area than traditional cases.

The cases described herein may include an opening mechanism that rotates a top lid of the storage case to access the storage space. In some examples the top lid portion of the case may include a snap fit onto the bottom portion of the case (e.g., body portion), which may be part of a permanent assembly that cannot be readily or constructively disassembled.

Any of the cases described herein may include a resistive indicator comprising a tactile indicator indicating when the case is open, when the case is closed, when the case is transitioning from a closed to an open configuration and/or when the case is transitioning from an open to a closed configuration. In some examples the resistive indicator may be a mechanical and/or magnetic interference between the lid and the base. For example, in some examples the apparatus may include one or more magnets on the lid that engage with one or more magnets on the base of the case in the closed and/or opened positions to give feedback indicating a maximum opening and/or closing.

For example, described herein are storage cases comprising: a hollow cylindrical portion configured to form an open cavity, the hollow cylindrical portion comprising: a base portion with curved sides surrounding a first inner surface; and an upper portion with curved sides at least partially surrounding a second inner surface, wherein the curved sides of the upper portion are coupled to the curved sides of the base portion, forming the cavity, wherein the upper portion includes an opening configured to provide access to the open cavity; a lid rotatably coupled to the hollow cylindrical portion and configured to rotate around and/or over the upper portion to selectively cover the opening in the open cavity and form an enclosed cavity configured to fully receive at least one dental appliance; and a resistive engagement between the lid and the hollow cylindrical portion.

The resistive engagement may include a magnetic engagement. Any of these apparatuses may include a snap-fit rotating joint configured to rotatably couple the lid to the hollow cylindrical portion. The resistive engagement may be configured to provide tactile feedback on the position of the lid relative to the hollow cylindrical portion. In some examples the resistive engagement is configured to: hold the lid in a position to uncover the opening in the upper portion of the hollow cylindrical portion; and hold the lid in a position to cover the opening in the upper portion of the hollow cylindrical portion. In some examples, the resistive engagement comprises at least one magnet disposed near the curved sides of the upper portion, the magnet configured to: hold the lid in a position to uncover the opening in the upper portion of the hollow cylindrical portion; and hold the lid in a position to cover the opening in the upper portion of the hollow cylindrical portion. The hollow cylindrical portion may include at least one drainage hole.

Also described herein are storage cases for a dental appliance that includes: a lid; a base having an open cavity configured to receive the dental appliance, wherein the base and the lid are operable to form an enclosed cavity between the lid and the base to enclose the dental appliance; a hinge comprising one or more biases configured to open the lid; a first releasable latch configured to secure the lid to the base; a second releasable latch configured to secure the lid to the base; a first user-actuated control configured to release the first releasable latch; and a second user-actuated control configured to release the second releasable latch, wherein the lid is configured to remain closed until both the first and second user-actuated controls are actuated.

The base may be configured to hold a palatal expander within the open cavity. The storage case may have a rectangular cuboid shape when the lid is closed.

Any of these storage cases may include an attachment region for coupling to a fastener, and/or a compartment in fluid communication with the open cavity configured to hold an odor reducing/preventing composition.

All of the methods and apparatuses described herein, in any combination, are herein contemplated and can be used to achieve the benefits as described herein.

### BRIEF DESCRIPTION OF THE DRAWINGS

A better understanding of the features and advantages of the methods and apparatuses described herein will be obtained by reference to the following detailed description that sets forth illustrative embodiments, and the accompanying drawings of which:

FIG. 1A shows an example storage case for one or more dental appliances.

FIG. 1B shows a detailed view of a hinge.

FIG. 2A shows an example spring.

FIG. 2B is an example of a cam having a cam profile.

FIG. 2C shows an example of a section through a storage case including a hinge as shown in FIGS. 2A-2B.

FIG. 3A illustrates different operating positions for an example of a case including a bias (e.g., cam) similar to that shown in FIGS. 2A-2C.

FIG. 3B shows an example of a displacement curve (showing a force distribution) for one example of a hinge including a cam similar to that shown in FIG. 3A.

FIGS. 3C-3D show examples of strain diagrams for a spring portion of a cam (e.g., cam follower) that may be included as part of a hinge of a case as described herein. FIG. 3C shows the spring in a relaxed configuration. FIG. 3D shows the spring is a compressed configuration (e.g., transitioning from a fully closed position towards a predetermined partially open position.

FIGS. 4A and 4B illustrate another example of a portion of a bias (e.g., cam) that may be used in any of the dental appliance cases described herein. FIG. 4A shows a spring formed of a wire, and FIG. 4B shows the spring of FIG. 4A forming part of the hinge assembly of a case.

FIG. 5A is an example base of a storage case.

FIG. 5B shows a top view of the base of FIG. 5A.

FIG. 6 shows a cross section view of a base.

FIG. 7 shows an exploded view of one example of a storage case.

FIGS. 8A-8F illustrate one example of a method of assembling a storage case as described herein.

FIGS. 9A-9F illustrate examples of case lid/base and spring angles for different stages of one example of a storage case as described herein.

FIGS. 10A-10E show various views of example storage case.

FIGS. 11A-11G show various views of another example storage case.

FIGS. 12A-12B show an example of a storage case with the lid open in a side perspective view (FIG. 12A) and a to perspective view (FIG. 12B).

### DETAILED DESCRIPTION

Dental appliances, such as dental aligners, retainers, mouthguards, and the like, may be worn by a patient for a variety of reasons. For example, dental appliances may provide a dental treatment, maintain tooth positions, or protect teeth during sporting events. Dental appliances are generally not worn continuously, but rather are temporarily removed for drinking, eating, dental hygiene, or the like. Some dental appliances may only be worn at night as the patient sleeps.

In some cases it may be particularly beneficial to provide dental appliance cases that can protectively store one or more dental appliance in a chamber that is covered by a lid that opens and closes in a manner that is assisted as well as resisted by one or more biases. Any of these dental cases may have multiple, predetermined lid positions, such as a closed position, a predetermined partially open position, and a predetermined fully open position. The lid may be configured to maintain itself in each of these predetermined positions, and may resist movement (further closing/opening) out of a predetermined position once the lid is in that predetermined position. These dental appliance cases may also be configured to automatically assume (or resume) one of these positions when the lid is moved to a nearby position. For example, any of the cases described herein may be configured to resist opening of the lid of the case until sufficient force is applied to overcome the one or more biases. Once the lid is opened sufficiently far to a first transition position (e.g., midway between the closed position and the partially open position, or some other point between the closed position and the partially open position), the one or more biases may provide a force to move the lid to the predetermined partially open position, even if no additional force is provided by the user to open the case. The case may then resist further opening (or further closing) of the lid from this predetermined partially open position, unless sufficient force is applied to overcome the one or more biases. If force is applied to overcome the one or more biases and further open the lid beyond a second transition position, the one or more biases may then provide sufficient force to self-open the lid to the predetermined fully open position.

In general, cases having both a predetermined partially open position and a predetermined fully open position may be particularly beneficial. The predetermined partially open position may allow a user to insert or remove a dental appliance from the partially opened case and prevent another dental appliance from falling out of the case. For example when storing multiple dental appliances within a single storage case, it may be helpful to partially open the case (e.g., to the stable partially open position) to provide sufficient room to insert or remove one appliance without disturbing any other appliances within the case. In some examples, the case may include multiple regions or compartments only some of which may be accessible in the partially open configuration. The cases described herein may permit the user to open the case to the predetermined partially opened case with one hand. The case may have a center of gravity that is balanced such that it is able to stand on its base when it is in the predetermined partially open position. Although it may be helpful to hold the case open in the partially open position, it may also be helpful to hold the case in a fully open position, such as when removing or inserting multiple dental appliances, cleaning the case, etc. In some examples the first open position (e.g., the partially open position) may allow the case to sit on a table or in a user's hand in this open configuration, without toppling backwards due to weight of the top half; the second open position (e.g., the fully open position) may provide a wider opening that may be easier to hold in the user's palm. In addition having different stable open positions may also allow the user to operate the device more discretely, e.g., to quietly insert their aligner into the case without looking at the case.

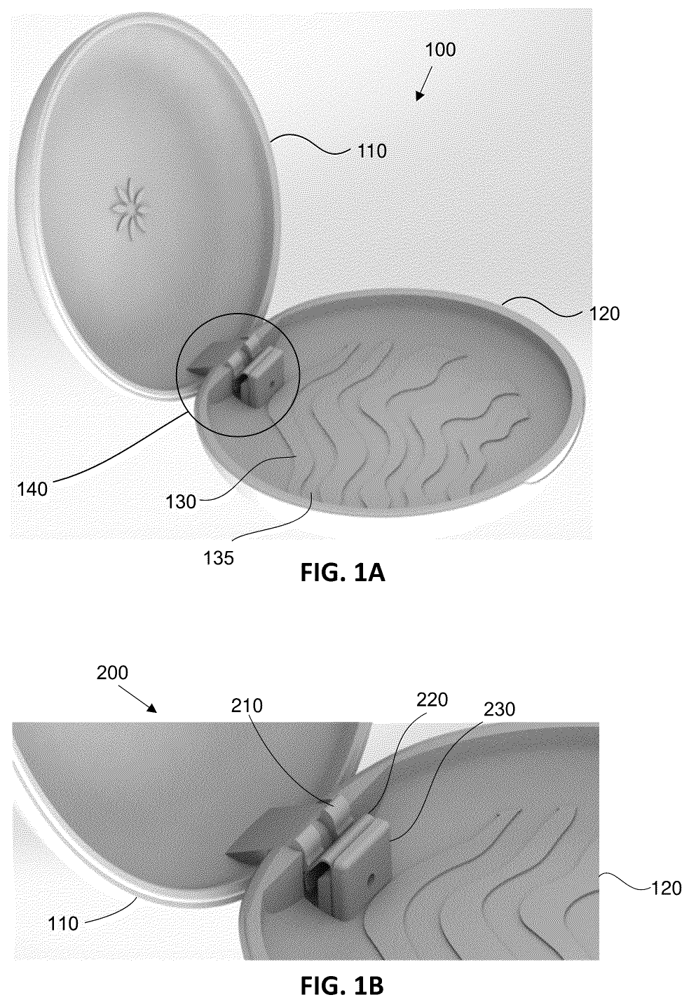

FIG. 1A shows an example storage case 100 for one or more dental appliances. The storage case may include a lid 110 and a base 120. The lid 110 and the base 120 may be formed from a polymer such as a polyethylene terephthalate material. In other embodiments, the lid 110 and the base 120 may be formed with any other feasible material. In some implementations, the material used for the lid 110 and the base 120 may be fully recyclable.

In some examples, the base 120 may include a raised pattern 130. An upper surface of the raised pattern 130 may generally be parallel to, but spaced away from an inner surface (e.g., floor) of the base 120. Thus, the raised pattern 130 may form one or more channels 135. The raised pattern 130 may support and/or elevate any dental appliances away from the inner surface of the base 120 thereby enabling water or other liquids to drain away from the dental appliances. For example, water may cling to the dental appliances after undergoing rinsing. The user may place the dental appliances in the storage case 100 where the raised pattern 130 enables water to drain from the dental appliances. In some examples, the base 120 may include one or more drainage holes (not shown) that allow water to drain and leave the storage case 100.

In some examples, the lid 110 and the base 120 may form an enclosed cavity to fully receive one or more dental appliances. The enclosed cavity may be formed when the lid 110 is closed upon the base 120.

The storage case 100 may include a hinge 140 to pivotably couple the lid 110 and the base 120 together. In some examples, the hinge 140 may be configured to hold the lid 110 in one or more relatively fixed positions, with respect to the base 120. For example, the hinge 140 may be configured to hold the lid 110 in a first position closed against the base 120, partially open in a second position with respect to the base 120, and fully open in a third position with respect to the base 120. In some other examples, the hinge 140 may be configured to hold the lid 110 in less than, or more than three positions.

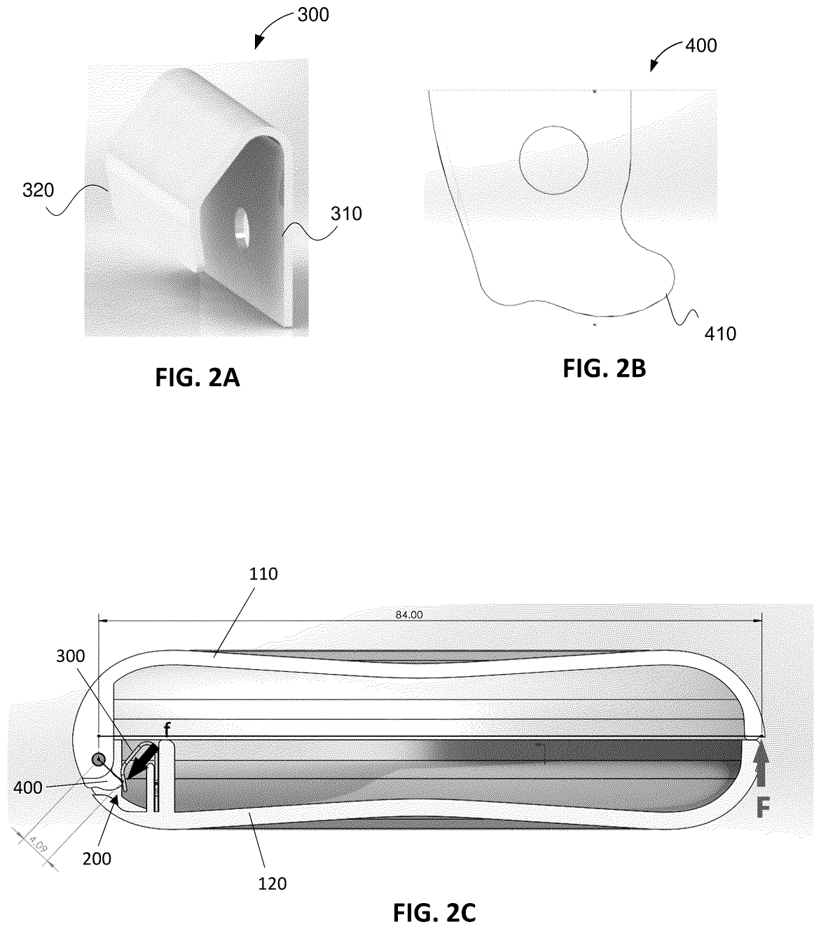

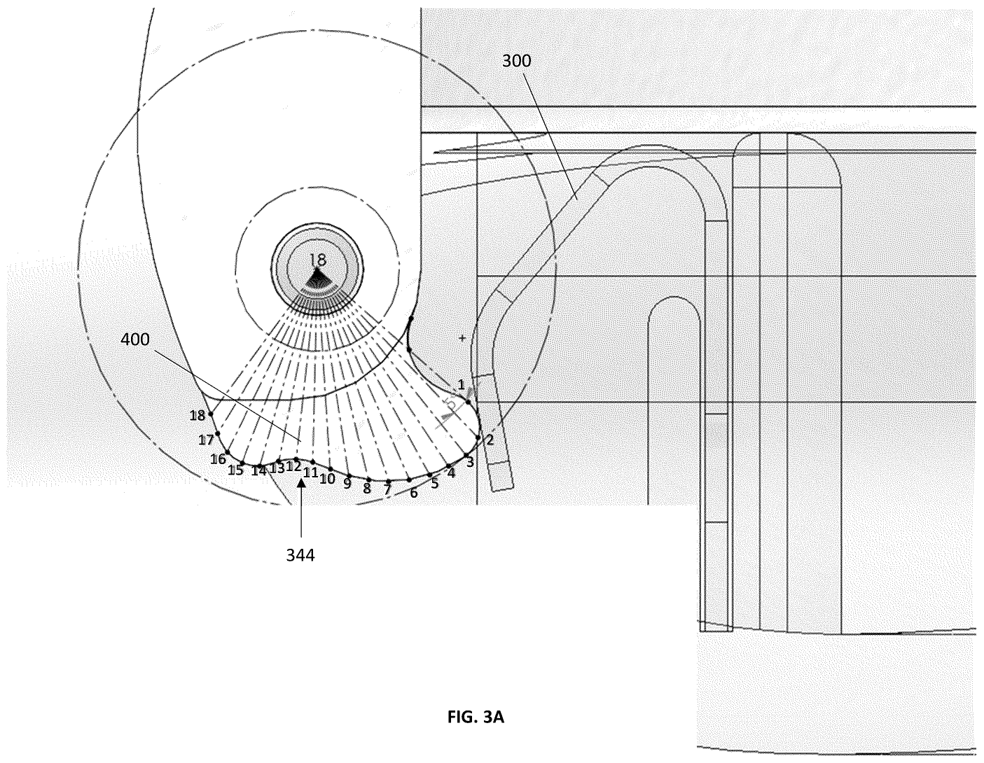

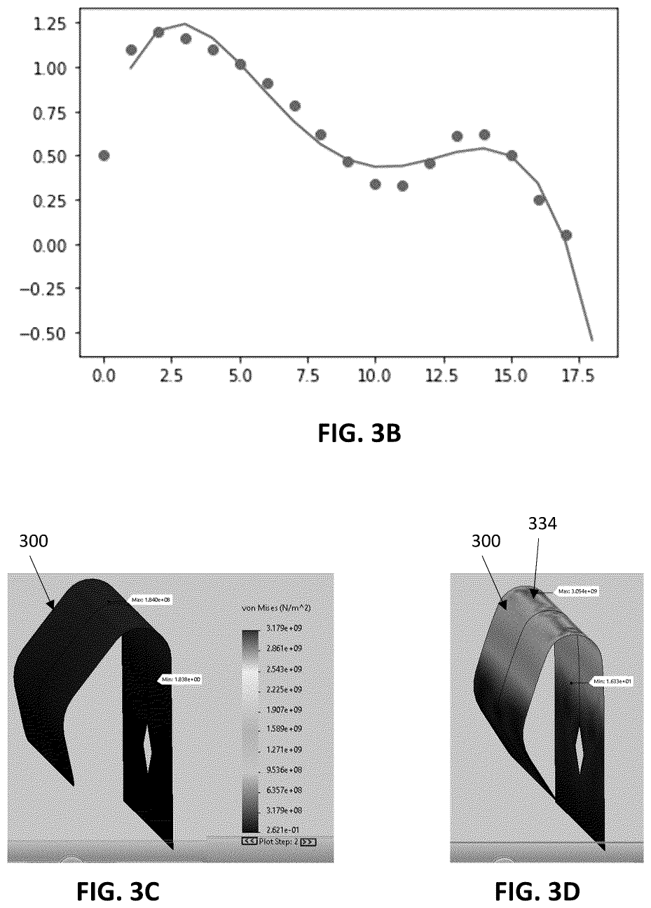

In FIGS. 1A-1B the hinge comprises a bias, configured as a cam, including a cam surface and cam follower, which are described in greater detail in FIGS. 2A-2C and FIGS. 3A-3D, below.

In the first position (i.e., the closed position), the hinge 140 may provide a force, such as a closing force to maintain a closing pressure between the lid 110 and the base 120. The closing pressure may advantageously assist in keeping any enclosed dental appliances contained with the storage case 100, and may resist opening of the case if, for example, the storage case is accidentally dropped onto the floor.

In the second position (i.e., the predetermined partially open position), the hinge 140 may provide a force to maintain the lid 110 in this partially open position that allows access to the interior of the base 120 while still allowing the storage case 100 to rest on a surface through the base 120. That is, in the predetermined partially open position the storage case 100 may be in a partially open position while stably resting fully on the base 120. For example, when the lid 110 is in the predetermined partially open position, the center of gravity of the storage case 100 may allow the storage case 100 to rest stably and completely on the base 120. In some examples, the predetermined partially open position may include holding the lid 110 at an angle of approximately ninety degrees or less with respect to the base 120 (e.g., between 20-90 degrees, between 30-90 degrees, between 50-90 degree, between 45-85 degrees, between 55-85 degrees, between 65-85 degrees, between 75-85 degrees, between 75-80 degrees, etc.).

In the third position (i.e., the predetermined fully open position), the hinge 140 may allow the lid 110 to be maintained at a more open position than the predetermined partially open position. For example, in the predetermined fully open position the lid 110 may open to an angle greater than ninety degrees with respect to the base 120 (e.g., between 90-180 degrees, between 90-170 degrees, between 90-160 degrees, between 90-150 degrees, between 90-140 degrees, between 90-130 degrees, between 90-120 degrees, between 95-120 degrees, between 100-120 degrees, between 110-115 degrees, etc.). In this manner, the predetermined fully open position may advantageously provide more room for a user's hand to grasp or otherwise access any dental appliance within the base 120. In some examples, when the lid 110 is in the fully open position, the resulting center of gravity of the storage case 100 may not allow the storage case to rest on a surface through the base 120. In these examples, in an example scenario, a user may open the lid to the partially open position if the user wants to rest the storage case on a surface, and may open the lid further to the fully open position when the user is able to hold the storage case in the user's hand for placing/removing a dental appliance within the storage case or for cleaning the storage case (if additional clearance is required). Having these two positions thus allows for a more optimal user experience, depending on how the user is using the storage case.

FIG. 1B shows a detailed view of a hinge 200. The hinge 200 may be an example of the hinge 140 of FIG. 1A. This hinge comprises a bias that applies force to open and close, and to resist opening and closing, of the lid 110 based on the position of the lid relative to the base 120. In some embodiments, this bias may include a cam surface and a cam follower configured to exert controlled biasing forces. In FIG. 1A the hinge 200 includes a cam surface 210, a cam follower comprising a spring 220 (e.g., a flat spring), and a spring holder 230. In some examples, the cam surface 210 may be included with (or in some cases molded into) the lid 110 and the spring holder 230 may be included with (or in some cases molded into) the base 120. In some other examples, the spring holder 230 may be included with the lid 110 and the cam surface 210 may be included with the base 120. In some embodiments, as illustrated in FIG. 1B, the spring 220 may be a separate element that is fastened (e.g., screwed) to the spring holder 230. In other embodiments, the spring may be an element that is formed integrally with the spring holder. In some examples, as illustrated in FIGS. 7, 8A-8F and 9A-9F, the spring holder may include an overhang that covers the top of the spring, so as to, e.g., protect the spring, reduce the likelihood of an ingress of liquids (e.g., saliva) in crevices between the spring and the spring holder, and/or reduce the likelihood of waste or bacterial buildup.

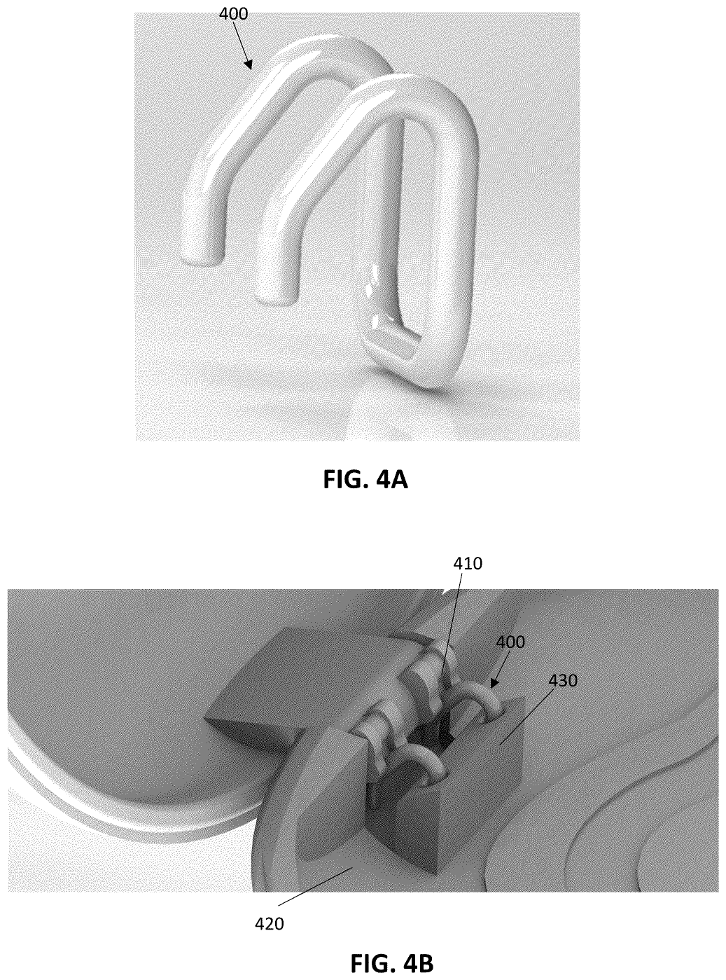

The cam surface 210 may be shaped to have a cam profile. The spring (cam follower) 220 may follow along the cam profile as it continues to engage the cam surface 210 as the lid 110 is pivotably moved with respect to the base 120. Thus, the spring 220 may exert a force against the cam surface 210 through the cam profile. In some examples, the cam profile may include one or more regions for the spring 220 to hold a position of the lid 110 with respect to the base 120. The cam profile is described in more detail below in conjunction with FIG. 2B, and the effects of the shape of the cam profile (and the associated cam follower) is described in more detail in conjunction with FIGS. 3A and 3B. FIG. 2A shows an example spring 300 configured as a cam follower. The spring 300 may be an example of a spring 220 such as shown in FIG. 1B. The spring 300 may be a flat spring (as shown) formed from a resilient material, e.g., spring steel. In other examples, the spring 300 may be formed from one or more wires (e.g., FIG. 4A). The cam follower may be formed of any appropriate material, such as stainless steel, nitinol, etc. In general all of the components of the cases described herein may be formed of a corrosion-resistant material, as they may be exposed to moisture (e.g., saliva, water, cleaning fluid, etc.) during ordinary use. Thus any or all of the components forming the case may be formed of a polymeric material, stainless steel, nitinol, etc., and/or may be coated with a corrosion-resistant material.

In some examples the cam follower (spring 300) may include a mounting surface 310 and cam follower region 320. The mounting surface 310 may engage with a feature on the lid 110 or the base 120 to hold or affix the spring 300. For example, the mounting surface 310 may engage with the spring holder 230. The cam follower region 320 may enable the spring 300 to apply pressure to a cam such as the cam surface 210. The pressure from the spring 300 may enable the lid 110 and the base 120 to remain in a fixed position, such as any of the positions described with respect to FIGS. 1A-1B.

FIG. 2B shows an example of a cam 400 having a cam surface with a profile (cam profile) that may be included with (e.g., molded as part of) any feasible cam surface, including the cam surface 210 of FIG. 1B. The cam profile may include one or more cam surface regions 410 that may engage with a cam follower to apply pressure. The cam surface region 410 can receive a force from a spring, such as spring 300 of FIG. 2A as the cam is moved against the cam follower (e.g., spring 300). In some examples, the cam surface may resist motion while the cam follower (spring 300) is in contact with the cam surface region 410. The profile of the cam may include different regions that may engage differently with the cam follower, resulting in different forces being applied as the two move against each other. For example, when a cam follower is in contact with the cam surface region 410 of the cam 400, the force from the spring 300 may hold the lid 110 in a particular position. Although only one cam surface region 410 is labeled in FIG. 2B, the cam profile may include any feasible number of regions. This is illustrated in FIG. 3A and described in greater detail below. For example, the cam 400 may have a cam provide with a first cam surface region (points 1-3 in FIG. 3A) corresponding to the region of the cam that interacts with the cam follower when this example of a device is between a closed position and the first transition position, a second cam surface region (points 3-12 in FIG. 3A) corresponding to the region of the cam that interacts with the cam follower when the device is between the first transition position to the partially open position, a third cam surface region (points 12-15 in FIG. 3A) corresponding to the region of the cam that interacts with the cam follower when the device is between the partially open position and the second transition position, and a fourth cam surface region (points 15-18 in FIG. 3A) corresponding to the region of the cam that interacts with the cam follower when the device is between the second transition position and the fully open position. As such the geometry (e.g., one or more of the shape, size, and/or curvature) of the cam surface regions determines at least in part the number of opening positions for the case and how the lid moves through each position (e.g., the amount of resistance, the locations of the positions and transition points). For example, a case may be configured to have more than two positions (e.g., two different partially open positions and one fully open position) by adding additional cam surface regions. In some embodiments, alternatively or additionally, the cam follower (e.g., spring) profile may be modified for the same or similar effect.

In some embodiments, the texture of the cam profile may be configured to provide a desired tactile experience when moving the lid through the different cam surface regions. For example, the cam surface regions interacting with the cam follower may include small protrusions (e.g., bumps, grooves) along its surface that cause a rough or bumpy sensation. As another example, the cam surface regions may be smooth to provide a smoother sensation. In some embodiments, some cam surface regions (or corresponding cam follower regions) may have different textures than other cam surface regions. For example, a first cam surface region may include protrusions, while a second cam surface may be smooth. In these embodiments, different sensation zones are created to enhance the user experience and provide tactile feedback. For example, cam surface regions with protrusions may be placed at the juncture between two different positions of the lid (e.g., the point between a transition point and the partially open position, a potion between a transition point and the fully open position, etc.) so as to indicate to the user that a new position is imminent. In some embodiments, similar textures can alternatively or additionally be applied to the cam follower (e.g., the spring 300) for a similar effect. In some example, a texture may also be present on the cam or spring surfaces.

In some examples, the cam profile 400 and other physical constraints may determine a resting position of the lid 110 and the base 120. For example, to hold the fully open position as described above with respect to FIG. 1A, the lid 110 may contact the base 120 in a manner that stops rotation about the hinge 200. The contact between the lid 110 and the base 120 that stops the rotation may occur while the cam follower (spring 300) is pushing on any region of the cam profile 400.

FIG. 2C illustrates an example of a case similar to that shown in FIGS. 1A-1B, including the lid 110, base 120 and hinge 200. The hinge is shown as a cam 400 including a cam surface and cam follower 300. The cam follower in this example is similar to the cam follower shown in FIG. 2A and comprises a spring. In FIG. 2C the case is shown with the lid in the closed position. Because the hinge is configured as a bias (e.g., a cam), the case will remain in this close position until a sufficient force (F), is applied to the lid to overcome the bias force of the cam (f) in this position. In FIG. 2C, as well as any of the figures shown here, the dimensions are examples only and other dimensions may be used (e.g., +/−5%, 10%, 15%, 20%, 30%, etc.).

As mentioned, the storage cases described herein may include one or more biases that provide multiple (e.g., two or more) stable open positions and apply a force to resist movement out of the stable open positions as well as driving opening into the stable open positions. In the example storage case shown in FIGS. 1A-1B and 2A-2C the bias is configured as part of the hinge region, and includes a cam including a cam surface and a cam follower. The shape of the cam surface and cam follower (as well as the material, e.g., the elastic material) forming the cam follower, e.g., spring, may be configured to set the positions and forces. This is schematically illustrated in FIG. 3A. FIG. 3A shows an annotated profile through the hinge region of the case of FIG. 1B. In this example, the cam surface is shown divided up into 18 points (labeled 1-18) along the cam profile. These points are divided up in this manner for illustrative purposes, and are not necessarily discrete points along the cam surface (i.e., the cam surface may be a smooth, continuous surface without discrete points). As the lid is opened or closed, these points represent the points of contact between the cam profile 400 and the cam follower (spring 300), which slide relative to each other. For example, when opening the lid from a closed position the user may initially overcome the force required to displace the cam follower (spring 300), e.g., between points 1-3, which may be referred to as a first region of ascent. In this example, the lid may be opened about 15 degrees, causing the spring 300 to compress (as shown in FIG. 3C, discussed below). Point 3 may also be referred to as the first transition position, after which the bias (e.g., the cam) transitions from inhibiting opening to driving opening of the lid to a predetermined partially open position. As the cam profile moves relative to the cam follower through points 3-12, also referred to herein as the region of first descent, the spring expands back outward and drives movement of the lid towards the partially open position; as such, the user may not have to apply any force to open the aligner case. The case opens itself due to spring force of the cam follower 300. Once the cam surface contacts the cam follower at about point 12, corresponding to the predetermined partially open position, the lid stops movement. From this predetermined partially open position the user may apply force to close the lid (pushing against the cam follower spring 300 initially to move through points 12 to 3) or to further open the lid. Further opening the lid request the user to apply force to advance through points 12-15, referred to herein as a region of second ascent. Although the case is in a stable position at point 12 in the predetermined partially open state, if the user opens the case further, they enter the region of second ascent in which the spring 300 is again compressed by the cam profile, requiring the user to overcome the resisting force of spring 300 to further open the lid until the lid reaches a second transition point at about point 15 in this example.

If the user opens the lid so that the cam profile engages with the cam follower (spring 300) at points 15-18, referred to herein as the region of second descent, the cam follower recoils due to negative slope of displacement curve, and the case self-opens the lid until the lid reaches the predetermined fully open position. The lid may therefore be fully opened and may maintain this fully open position.

The two predetermined opened positions (predetermined partially open position and predetermined partially open position) are reflected in the inflection region 344 of the cam profile as well as the bent or curved shape of the cam follower in this example.

The lid may be closed from the predetermined fully open position to the predetermined partially open position by reversing the steps described above, e.g., moving the contact points from point 18 to point 1, however the user must initially apply force to resist the self-opening force applied by the cam (between points 18 to 15) then the lid may self-close toward the predetermined partially open position (from points 15 to 12). Similarly, the user may close the lid from the predetermined partially open position by resisting the self-opening force (from points 12-3) tending to restore the lid to the predetermined partially open position and the lid may then self-close between points 3-1.

The relationship between the cam profile and the displacement of the lid is shown in FIG. 3B. In this example, an equation describing the force needed to achieve the displacement of the lid (corresponding to the positions of the points 1-18, representing rotation from 0 to 85 degrees of the lid) may be determined and modeled as an equation, shown by the solid line. In this example, the displacement curve may be fit to a curve such as:

$$D = - 0.0003746 {x}^{4} + 0.01352 {x}^{3} - 0.1587 {x}^{2} + 0.5983 {x}^{1} + 0.5406 ,$$

where x is between 0 to 1.25 mm, or 0 to 2 mm, or 0 to 3 mm. The actual force required may be set based on the shape of the cam (e.g., the cam profile) and the shape of the cam follower, and/or the material properties of the cam and the cam follower. For example, the force required to initially open the lid (when x=0) may be set to be approximately 95 Newtons (95 N). Since the force to open is applied through the length of the lid, the actual applied force may be a fraction of this (e.g., approximately 4.4 N). In the example shown in FIG. 3A, the force required to open the lid may increase up to the first transition point (e.g., to approximately 11 N), before transitioning to an opening force to open the lid, as described above.

FIGS. 3C and 3D show examples of heat-maps for a cam follower, spring 300. In FIG. 3C the spring is shown in an uncompressed (unstressed) configuration. In FIG. 3D the spring is shown compressed (e.g., at position 3 in FIG. 3A). The bending of the spring at the apex 334 may store the energy that may then be used to drive self-closing or self-opening of the lid.

Any appropriate cam follower/spring may be used. In the example shown in FIGS. 3A-3D the cam follower is a flat spring or clip. In some examples the cam follower comprises one or more resilient wires. For example, FIG. 4A shows a cam follower 400 configured as a resilient wire (e.g., a metallic wire) that may engage with the surface of the cam profile. FIG. 4B shows the cam follower 400 of FIG. 4A incorporated as part of the cam forming the hinge of a case, including a spring holder 430 securing the cam follower to the base 420, and a cam surface 410.

### Drainage

Any of the storage cases described herein may also be configured to provide drainage so that fluid is removed from the chamber of the case, and therefore away from any dental appliances held within the case. One or more drains may be positioned at or near the hinge region. Further the base of the case may be titled at an angle towards the hinge region (e.g., the base plane of the case may be at an angle with a level ground surface on which the case rests). In any of these cases, the base may include a raised (e.g., embossed) surface that is configured to guide fluid towards the drain feature when the storage case is resting on a flat surface.

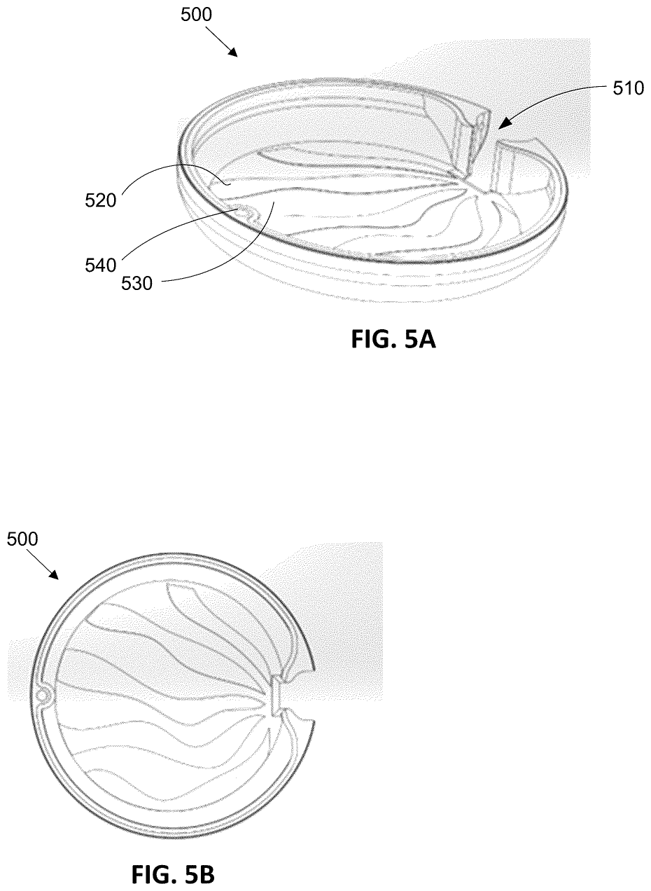

FIG. 5A is an example base 500 of a storage case. The base 500 together with a lid (not shown) may form an enclosed cavity that can receive one or more dental appliances. The base 500 includes a drainage hole 510, a raised pattern 520, one or more channels 530, and (in this example) a magnet 540. In some examples, the base 500 may include a subset of the foregoing features, or additional features.

The drainage hole 510 may provide an opening though which any fluids that have collected within the base 500 can drain. Although only one drainage hole 510 is shown in FIG. 5A, in other examples, the base 500 may include any number of drainage holes. As shown, the drainage hole 510 may be disposed in a floor and a side wall of the base 500. Allowing fluids to drain may advantageously reduce or limit the growth of mold, mildew, bacteria, or the like. The interior of the base 500 may include a raised pattern 520 to elevate the dental appliance above an inner surface of the base 500. The raised pattern 520 may form the one or more channels 530 that can guide fluids to the drainage hole 510. In some examples, the raised pattern 520 may be curved (e.g., wavy) and, therefore, form one or more curved channels (e.g., the wavy channels 530). Although a particular pattern is shown in FIG. 5A, any suitable pattern is contemplated. For example, in some examples, the raised pattern may be straight and may form straight channels toward the drainage hole. As another example, when there are multiple drainage holes, the base may include multiple sets of channels that are each directed to a respective drainage hole.

Although FIG. 5A illustrates a storage case with a drainage hole 510 positioned at one side of the storage case, a drainage hole may be positioned at any suitable location. For example, a drainage hole may be positioned toward a center of the storage case. In this example, the storage case may include channels that are formed radially to guide fluid in the storage case toward the center. The interior of the base of the storage case may be sloped radially toward the center of the storage case to allow for drainage toward the drainage hole.

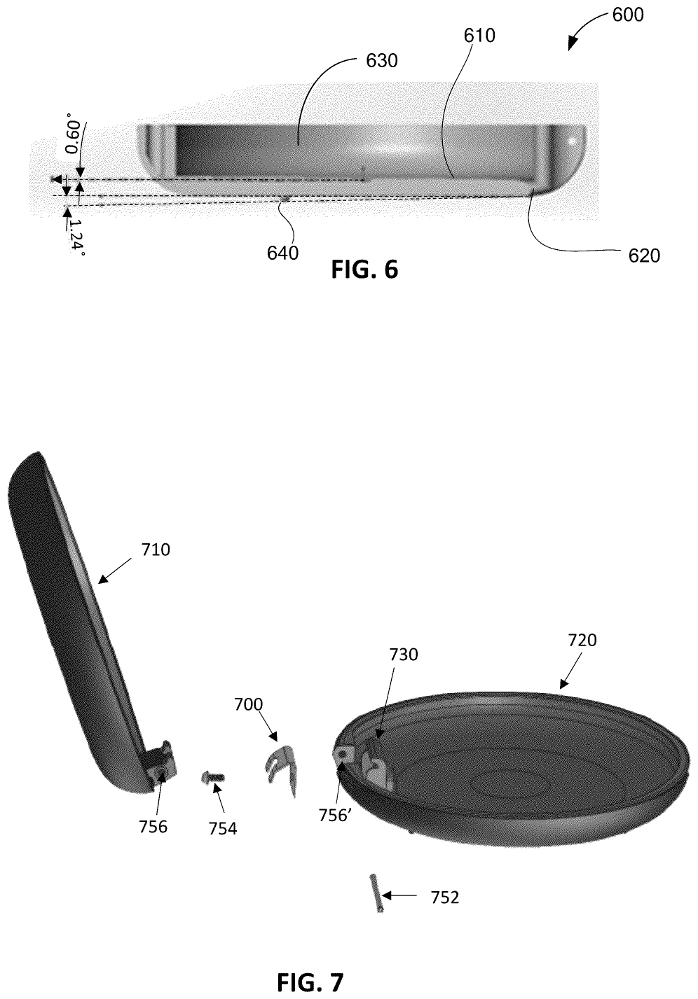

In some embodiments, drainage may be achieved without a raised pattern by simply adjusting a slope of the base. For example, an interior surface of the base may be sloped toward a drainage hole as described below with respect to FIG. 6.

In the example shown in FIGS. 5A-5B, a fastener 540 may be used to help secure the device in the closed configuration. In some embodiments, the fastener 540 may be a magnet, a latch mechanism, a snap-fit mechanism, a hook, a hook-and-loop fastener, etc. This may be used in addition to or instead of the bias described above. In FIG. 5A, the fastener 540 may be, for example, a magnet may be attracted to a corresponding magnet or ferrous material in a corresponding lid (not shown). The fastener 540 may attract and provide a closing force between the base 500 and the lid. In this manner, the fastener 540 may assist in preventing accidental opening of a storage case. Furthermore, the base 500 may be molded to include a sloping surface to enhance fluid drainage through the one or more channels 530 and the drainage hole 510.

In other examples, a drainage hole may be disposed in any feasible region of the base 500. For example, a drainage hole may be located away from any wall and instead be centrally located within a floor of the base 500, including any of the channels 530. In addition, the channels 530 may be sloped so that any liquids that are collected by the channels 530 are directed to any included drainage holes. FIG. 5B shows a top view of the base 500.

FIG. 6 shows a cross section view of a base 600. The base 600 may be an example of the base 500 of FIG. 5. An inner surface 610 of the base 600 (which may sometimes be referred to as a floor) may be sloped toward a drainage hole 620. In some examples, the inner surface 610 may have a slope of approximately 0.60 degrees. This slope may tilt the inner surface 610 and allow liquids to be directed to the drainage hole 620 without being overly noticeable to the user.

In some examples the base 600 may include one or more feet 640 on an outer surface of the base 600. The feet 640 may tilt the inner surface 610 toward the drainage hole 620. In some cases, the feet 640 may tilt the base 600 approximately 1.24 degrees. The feet 640 may be used alternatively, or in addition to, the slope of the inner surface 610 to help drain liquids from the base 600.

The base 600 and lid (not shown) may be formed from an injection molded plastic. In some embodiments, the base 600 and the lid may be formed from Vesaflex OM3060. The base 600 may optionally include a liner 630. The liner 630 may also be formed from an injection molded plastic. In some examples, the liner 630 may be formed from a hydrophobic material.

In addition, or alternatively, a base (e.g., the base 500, the base 600) may include a reservoir (not shown) to catch and collect any fluids that pass through its one or more drainage holes. The reservoir may detachably couple to the base. For example, the reservoir may snap onto the base to collect fluids and may later detach (unsnap) from the base to be emptied.

The storage cases described herein may be assembled in any appropriate manner. For example, FIG. 7 illustrates one example of a method of assembling a storage case including a lid 710, a base 720, a spring 700, a screw 754 and a hinge pin 752. The base 720 in this example may be formed (e.g., molded, including injection molded) to include a spring holder 730 with a threaded insert in the spring holder. The spring 700 may be attached to the spring holder 730 and therefore the base 720 and secured by the screw 754. The lid 710 may then be assembled onto the base 720 by compressing the spring 700 (e.g., by approximately 1 mm) to align the hinge holes 756, 756′ and inserting the hinge pin 752.

As mentioned above, in any of these storage cases the spring mechanism, including the spring holder 730 portion, may be configured to be isolated from the rest of the interior of the base and/or lid. In FIG. 7 the spring holder is configured to surround the spring 700 and the interface between the cam and the spring. This may reduce the likelihood of accumulation of bacteria, mold, dirt, and/or other contamination in the hinge mechanism.

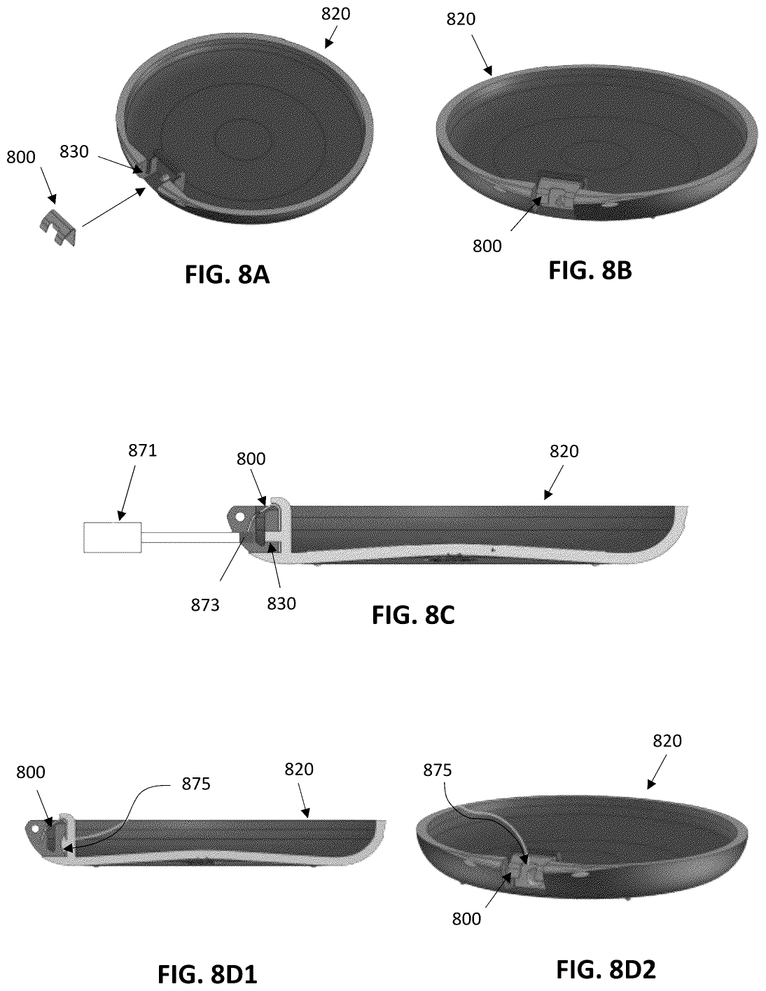

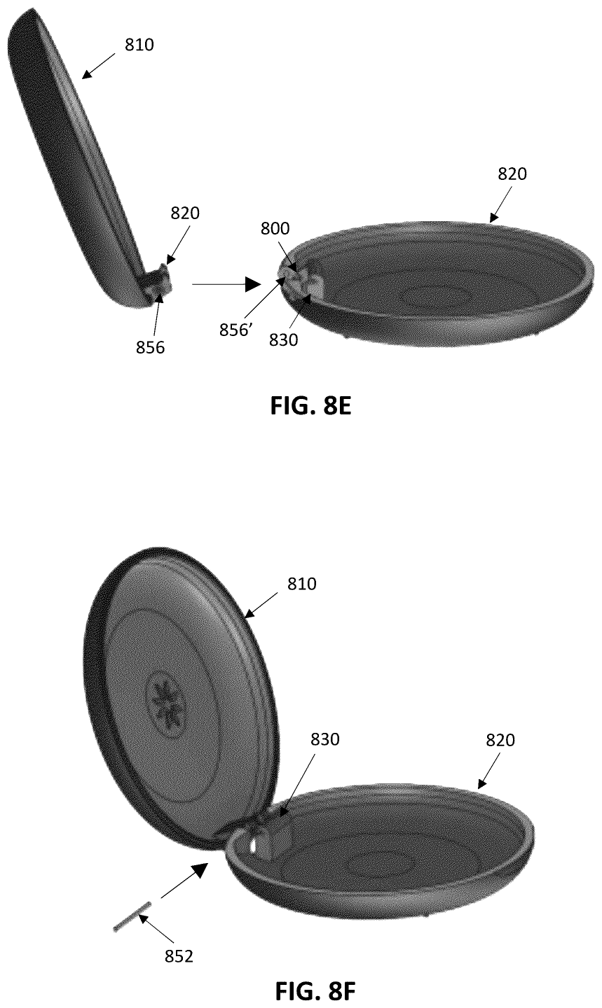

FIGS. 8A-8F illustrate another example of a method of forming a storage case. In this example the spring holder 830 (e.g., spring cover) on the base may include a plastic boss 875 that may be melted to form a secure connection between the spring 800 and the spring holder 830. In FIG. 8A (step 1) the spring 800 may be coupled to the spring holder 830 of the base 820, as shown in FIG. 8B, and positioned with an opening in the spring 800 aligned with the boss. As shown in FIG. 8C, a heat staking tool 871 may be used to melt the material of the boss 875 (using a hot end 873 of the heat staking tool) so that it secures the spring to the spring holder. As shown in FIGS. 8D1 and 8D2, the extruded boss 875 may be flattened to form a button that securely holds the spring 800 to the base 820. In FIG. 8E the cam region 820 of the lid 810 may then be aligned with the spring holder (e.g., by aligning hinge holes 856, 856′ and inserting the hinge pin 852, as shown in FIG. 8F.

In operation the lid 820 may be opened and closed to one or of predetermined positions relative to the base. The hinge assemblies described above may provide a storage cases that is configured to remain securely closed even when dropped on the ground, which may prevent dental appliances held with the case from spilling out. The mechanical leverage applied by the one or more biases (e.g., the cam and spring configuration in FIGS. 7, 8A-8F and 9A-9F) may provide mechanical leverage that may both resist changing from the predetermined closed, predetermined partially open and predetermined fully open configurations, but may also assist in transition to each of the configurations once the lid is moved at least partially from one configuration towards the next configuration.

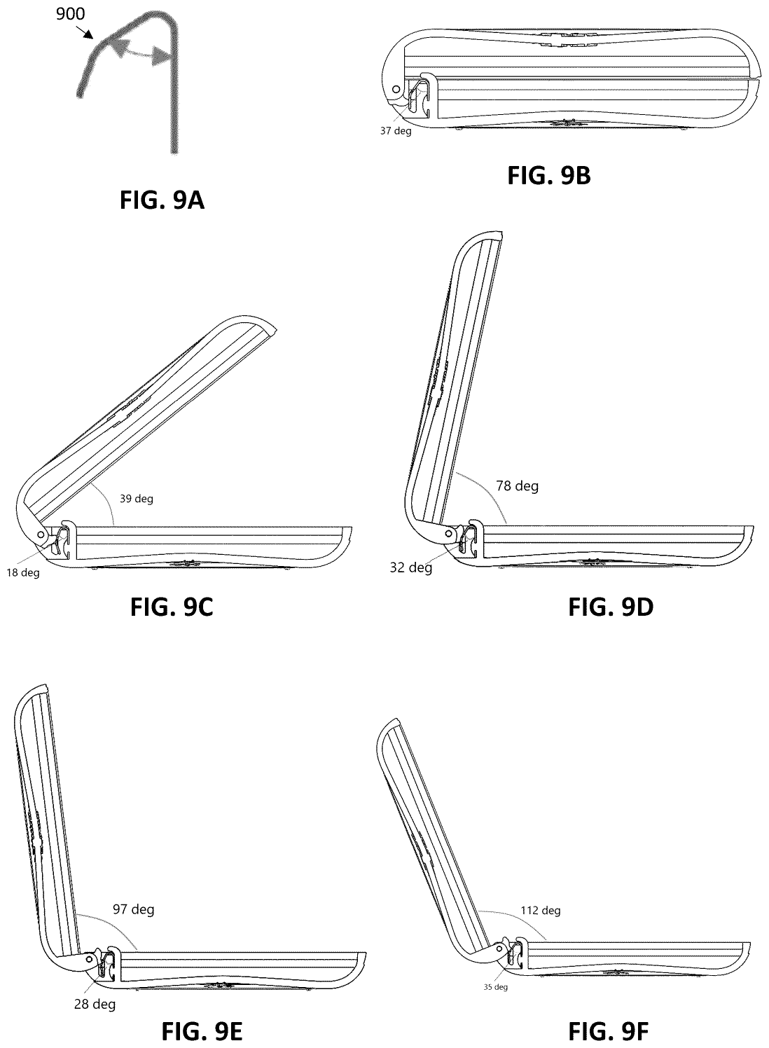

For example, FIGS. 9A-9F illustrate exemplary angles between the lid and the base, as well as the angle of the spring, for a variety of predetermined configurations (“states”) of one example of a storage case. FIG. 9A shows an example of a spring 900 at rest, prior to inserting it into a case. In this example the spring 900 has a resting spring angle of approximately 57 degrees. FIG. 9B shows an example of the storage case closed (e.g., in the predetermined closed configuration) so that the angle between the lid and the base is approximately 0 degrees. The spring angle within the case is approximately 37 degrees. FIG. 9C shows the storage case being opened, halfway between the closed state and the predetermined partially open configuration. The spring angle within the case in FIG. 9C is approximately 39 degrees relative to the base. FIG. 9D shows the same storage case with the lid in the predetermined partially opened configuration and with the spring angle approximately 28 degrees. In this configuration the lid may be stable maintained at an angle of about 78 degrees. Moving the lid from this position, either further opened or further closed, may be resisted by the hinge mechanism, which tends to restore the lid to this partially opened configuration. The spring angle in FIG. 9F is approximately 35 degrees. FIG. 9E shows the storage case opened midway between the predetermined partially open configuration and the predetermined fully open configuration, with the lid opened approximately 97 degrees. The angle between the lid and the base in the predetermined fully open configuration shown in FIG. 9F is approximately 112 degrees.

Any of the storage cases described herein may include one or more markings (e.g., visible marking and or tactile markings) or features to make it easier to use the storage case in dark conditions or for people with limited eyesight. For example, either the lid, the base, the spring and/or any combination of these elements may include one or more visual and/or tactile features that indicate the orientation and or state (open/closed state) of the storage case. For example, the storage case lid may include one or more tactile features (e.g., protrusions) to assist the user to distinguish between top/bottom, lid/base and/or hinge. Thus, any of these storage cases may be configured to provide features to assist in removing, storing and/or positioning the dental appliance, including tactile features, such as, but not limited to, a protrusion on the top of the appliance, a different trimming of the aligner cut line at one or more points of the appliance), etc.

Any of the cases described herein may include one or more (e.g., 2 or more, 3 or more, etc.) dedicated compartments for each of the dental appliances to be used for all or a portion of a dental/orthodontic treatment. In some examples the compartments may instead by regions that are only partially enclosed or unclosed. These different compartments/regions may include a holder for holding he dental appliance(s). For example, a dental appliance storage case may include a holder for an upper appliance on the lid and one for a lower appliance on the base. In this example, the compartments may include a tactile feature (e.g., a protrusion), such as a protrusion only on the compartment for the top appliance. The dental appliance storage case may thus hold one or more dental appliances so that the dental appliances do not move around within the case, and the user may readily determine which appliance is for which jaw. In some examples a holder includes a mounting fixture for the dental appliance configured to be worn on an upper and/or lower jaw. For example, the case may include a holder configured as a mount on the lid and/or on the base of the storage case. A mounting fixture may be one or more cylindrical posts or tooth-shaped projections, or an arch corresponding to a dental arch, onto which an appliance can be directly mounted. For example, a mounting fixture that may be included may have two molar-shaped projections for the left side and the right side and may be configured to support an appliance on to the projections.

Any of the storage cases described herein may also include one or more mirror surfaces (e.g., mirrors) so that the user may look at their reflection when applying or removing the dental appliance. For example, a mirror may be included in the inner lid. Alternatively or additionally a mirror may be included in the base. The mirror may be on an internal and/or external surface.

### Two-Piece Storage Cases

The dental appliance storage cases described herein may be configured as two-part storage cases that can be opened and closed, e.g., by a relative rotation (e.g., twisting) between the two parts. For example, the dental appliance storage cases may be formed of two or three parts that may be injection molded. The material may be a recyclable plastic material, such as, but not limited to, PET. The storage case may be configured to open and close by twisting using a threaded male and female feature at the center of the bottom half and the top half of the storage case. For example, the bottom half may have a holding feature to help in the twist/screw action. Since the top and bottom halves may close together completely, the aligners may be held securely in the case and prevented from falling out even if the case falls on the ground; the case typically does not open on such impact.

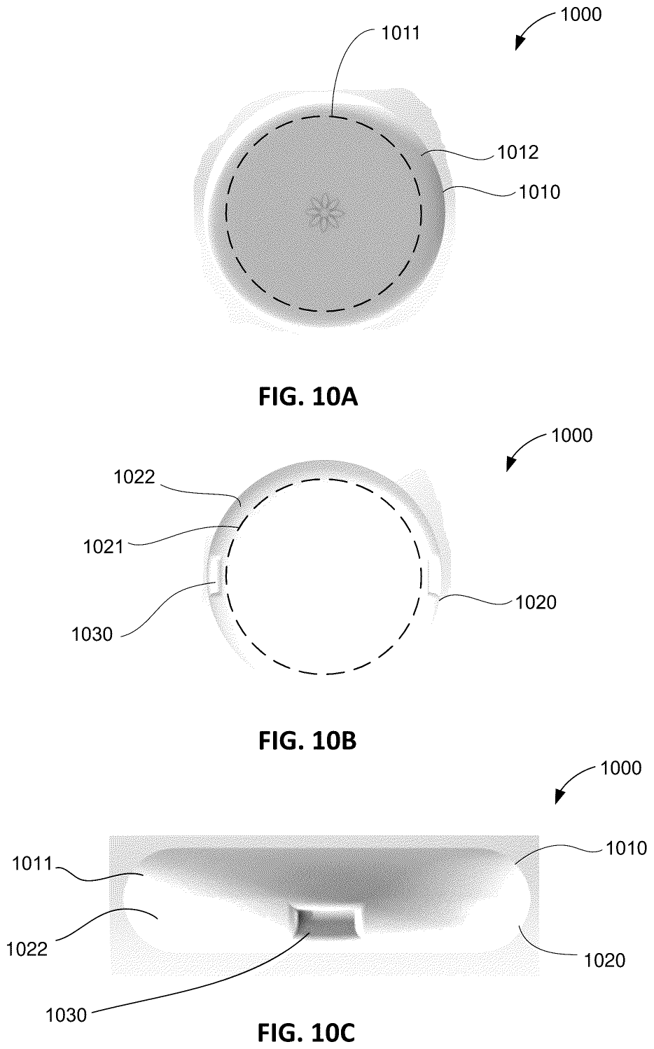

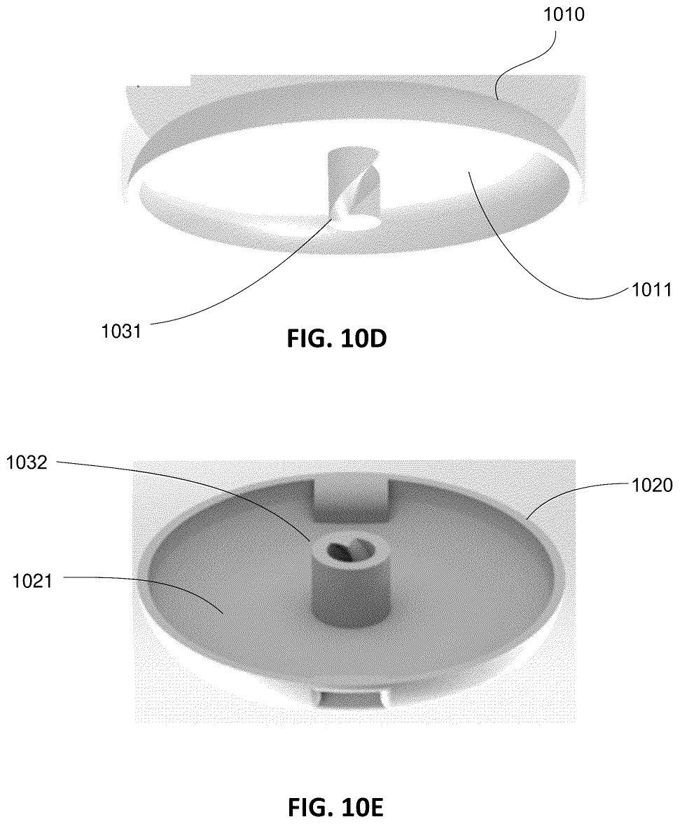

FIGS. 10A-10E show various views of another example storage case 1000. FIG. 10A is a top view of a lid 1010 of the storage case 1000. The storage case may be formed with an injection molded plastic such as polyethylene terephthalate. In some examples, the storage case 1000 may be formed from recyclable material. The lid 1010 may have a flattened dome shape and consist of a flat disk section 1011 and sides 1012 extending from a circumference of the disk section 1011. FIG. 10B is a bottom view of a base 1020 of the storage case 1000. Similar to the lid 1010, the base 1020 may include a flat disk section 1021 and sides 1022 extending from a circumference of the disk section 1021. An enclosed cavity is created when the lid 1010 is placed in contact with the base 1020.

The base 1020 can include one or more finger grips 1030. The finger grips 1030 can enable the user to firmly grasp the base 1020 and apply a twisting motion. The twisting motion can attach or detach the base 1020 from the lid 1010. In some examples, the base 1020 may include drainage holes (not shown) to enable liquids to drain from inside the storage case 1000. As discussed previously, the base may include one or more channels and/or may be sloped to guide fluids toward one or more drainage holes.

FIG. 10C is a side view of the storage case 1000. The lid 1010 may be coupled to the base 1020 through a separable threaded joint (not shown). In some examples, twisting the base 1020 relative to the lid 1010 may operate the threaded joint. In this manner the base 1020 can be coupled or uncoupled from the lid 1010. As shown, when the lid 1010 is coupled to the base 1020, sides 1012 of the lid may contact sides 1022 of the base 1020. Additionally, the threaded joint may temporarily lock the base 1020 together to the lid 1010. In this manner, any dental appliances stored in the storage case 1000 may be secured even when the storage case 1000 accidentally falls to the ground.

FIG. 10D is an inside view of the lid 1010. One portion of a separable threaded joint 1031 is disposed approximately centered with respect to the lid 1010, particularly with respect to the disk section 1011. In the example lid 1010, the separable threaded joint 1031 is male, however in other examples, the separable threaded joint 1031 can be female. In other examples, the threaded joint may be located at or near a circumference of the case.

FIG. 10E is an inside view of the base 1020. Another portion of a separable threaded joint 1032 is disposed approximately centered with respect to the base 1020. More particularly, the separable threaded joint 1032 is approximately in the center of the disk section 1021. In the example base 1020, the separable threaded joint 1031 is female, however in other examples, the separable threaded joint 1031 may be male.

The lid 1010 may be coupled to the base 1020 through the separable threaded joints 1031 and 1032. Typically one of the threaded joints can receive the other threaded joint. For example, the separable threaded joint 1032 can receive the separable threaded joint 1031. The receiving separable joint (in this example the female separable joint 1032) may include a flared or enlarged opening to ease insertion of the separable threaded joint 1031. Alternatively, or in addition, a shaft section of the separable threaded joint 1031 may be tapered to ease insertion into the separable threaded joint 1032.

### Tactile Feedback

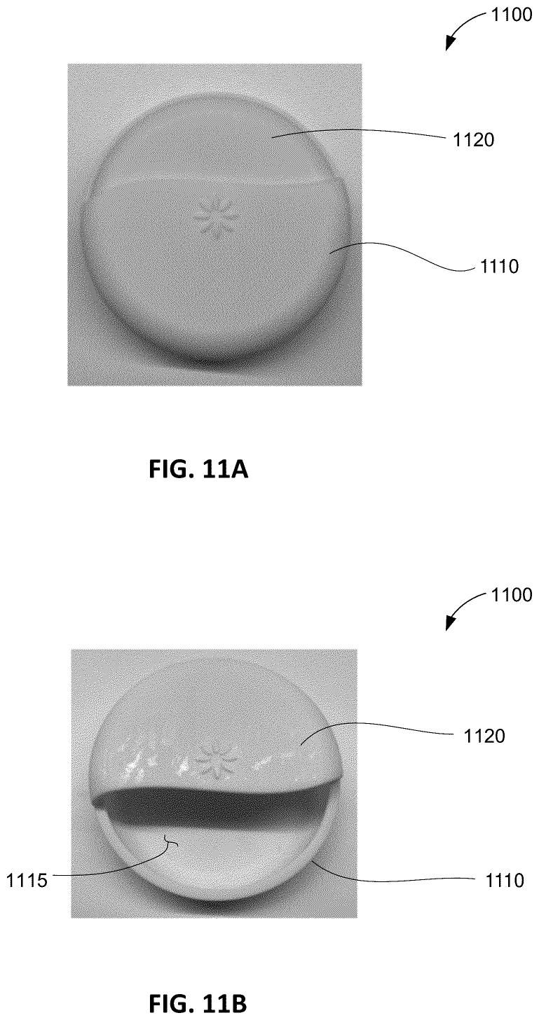

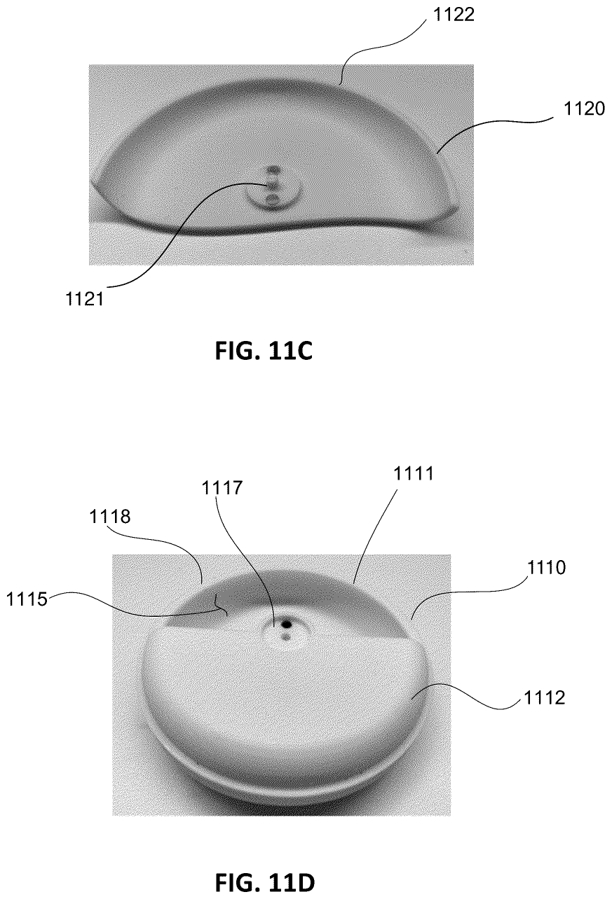

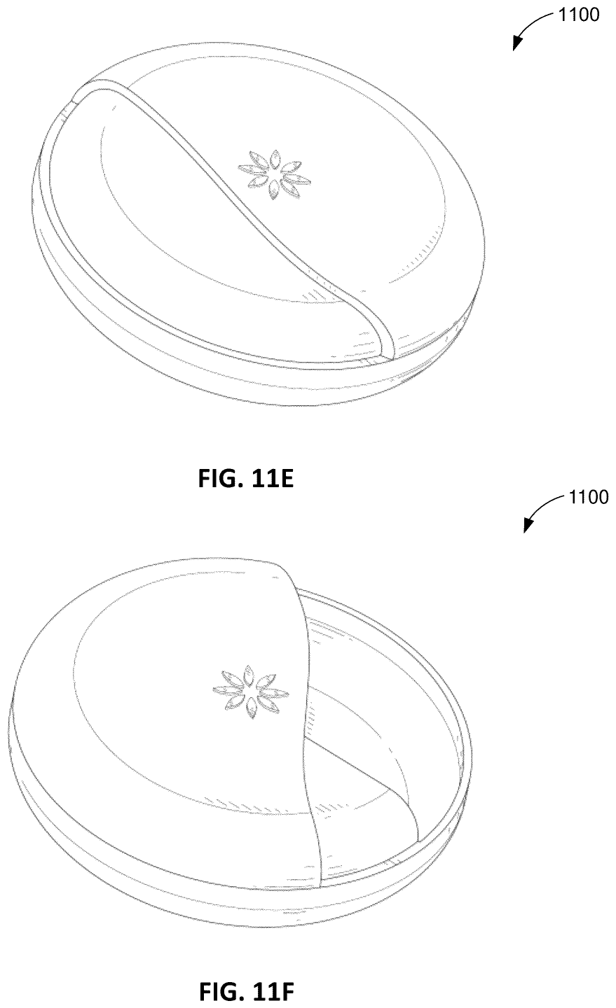

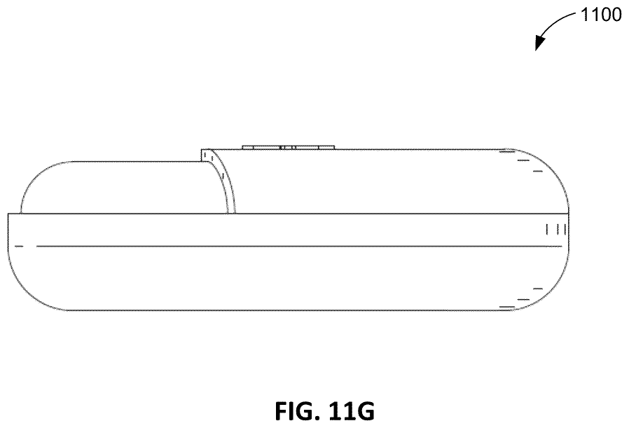

Any of the storage cases described herein may provide feedback to the user that the case is closed/open or is transitioning from the open to closed configurations. Tactile feedback may be particularly useful with cases having covers or lids that rotate relative to the base. For example, FIGS. 11A-11G show various views of another example storage case 1100 in which the lid 1120 may rotate to open/close the case. In FIGS. 11A-11G the storage case 1100 can include a hollow cylindrical portion 1110 and a lid 1120. The lid 1120 may be rotatably coupled to the hollow cylindrical portion 1110 through a snap-fit rotating joint, e.g., around the circumference of the base cylindrical portion 1110. Together, the hollow cylindrical portion 1110 and the lid 1120 may form an enclosed cavity to fully receive at least one dental appliance. FIG. 11A shows the storage case 1100 in a closed configuration. The lid 1120 may be positioned (moved) over an opening in the hollow cylindrical portion 1110 thereby forming the enclosed cavity. FIG. 11B shows the storage case 1100 in an open configuration. The lid 1120 may be positioned away from opening 1115 in the hollow cylindrical portion 1110. In this manner, a user may have access to the cavity within the hollow cylindrical portion 1110.

In some examples, the storage case includes one or more resistive engagements between the lid 1120 and the cylindrical base 1110 that may provide tactile feedback to a user rotating the lid relative to the base. The tactile feedback may be felt (or in some cases heard) as a click vibration, and/or an increased resistance to rotation. In any of these examples, the tactile feedback may be part of a mechanical and/or frictional engagement between the lid and the base. Alternatively or additionally the tactile feedback may be a magnetic engagement.

For example, FIG. 11C is an inner view of the lid 1120. The lid 1120 may be shaped to cover the opening 1115 of the hollow cylindrical portion 1110. The lid 1120 may also include a first portion of a snap-fit rotating joint 1121. In some examples the snap-fit rotating joint 1121 may include at least one magnet, forming a magnetic engagement. The magnetic engagement may be centrally located (as shown in FIGS. 11C and 11D) or it may be offset to peripherally positioned. The magnetic engagement may include one or more magnets. For example, the magnet may interact with a second portion of the snap-fit rotating joint (not shown) on the hollow cylindrical portion 1110 to hold the lid 1120 open or closed with respect to the opening 1115.

The lid 1120 may include curved sides 1122. In some examples, the curved sides 1122 may include one or more magnets to interact with other magnets or ferrous material that may be included with the hollow cylindrical portion 1110.

FIG. 11D is a view of the hollow cylindrical portion 1110. In some examples, the hollow cylindrical portion 1110 may include a base portion 1111 and an upper portion 1112. The base portion 1111 may be formed separately from the upper portion 1112, and then bonded together. In some other examples, the hollow cylindrical portion 1110 can be injection molded as a single piece.

The hollow cylindrical portion 1110 includes an open cavity accessible through the opening 1115. The hollow cylindrical portion 1110 may include the second portion of the snap-fit rotating joint 1117. In some examples the second portion of the snap-fit rotating joint 1117 may include at least one magnet. The magnet may interact with the first portion of the snap-fit rotating joint 1121 on the lid 1120 to hold the lid 1120 open or closed with respect to the opening 1115. In some examples, the base portion 1111 may include curved sides 1118. The curved sides 1118 may include at least one magnet. The magnet may interact with a magnet or ferrous material on the lid 1120 to hold the lid 1120 open or closed with respect to the opening 1115.

Notably, the storage case 1100 may lack any features that extend through the cavity of the hollow cylindrical portion 1110. In this manner, the cavity may provide unimpeded space to receive a variety of dental appliances.

FIGS. 11E-11F show additional views of the storage case 1100. FIG. 11E shows an isometric view of the storage case 1100 in a closed configuration. FIG. 11F shows an isometric view of the storage case 1100 in a partially open configuration. FIG. 11G shows a side view of the storage case 1100.

### Odor Prevention and Mitigation

Any of the storage cases described herein may be configured to reduce and/or prevent odor. For example, any of these apparatuses may include a compartment or region for receiving and/or dispensing an odor-reducing and/or odor-preventing composition (“odor reducing/preventing” composition). The odor reducing/preventing composition may be solid, liquid, and/or gel and may be released and/or dispensed from the compartment. In some cases the compartment may be used to release and/or dispense the odor reducing/preventing composition, e.g., into the enclosed cavity holding the dental appliance. This release may be a timed release. For example, any of these apparatuses may include a compartment or region for holding a consumable anti-odor (e.g., anti-bacterial) composition such as a tablet, powder, packet, liquid, gel, etc., so that the anti-odor composition may be released or emitted, e.g., volatilized, into the enclosed cavity configured to hold the dental appliance.

Alternatively or additionally, the odor reducing/preventing composition may absorb, capture and/or sequester odors. For example, the compartment holding the odor reducing/preventing composition may be open and/or may be vented into the enclosed cavity of the case to allow air to be exchanged between the compartment and the housing. In some examples the apparatus may include a filter, grating, mesh, etc. between the compartment and the enclosed cavity.

Any appropriate odor reducing/preventing composition may be used, such as (but not limited to): sodium bicarbonate (baking soda), activated charcoal, acid (e.g., white vinegar, citric acid/lemon juice, etc.), alcohol, an oil (e.g., tea tree oil, witch hazel oil, etc.), etc. In some cases the anti-odor compositions may include enzymes. In some cases the anti-odor composition may neutralize and/or absorb the odor. In some cases the anti-odor composition may be or may include a fragrance (e.g., peppermint, lavender, orange, etc.). Any of these odor reducing/preventing compositions may be anti-bacterial compositions.

The compartment for the odor reducing/preventing composition may be present in any appropriate region of the case. For example, the odor reducing/preventing composition compartment may be integrated into the hinge region, such as the spring holder 230, 430 (in reference to FIGS. 1A-1B and 4B). The compartment or region for receiving and/or dispensing an odor reducing/preventing composition may be accessible from the outside of the case and/or from within the enclosed cavity holding the dental appliance. In some examples the anti-odor composition may be periodically (e.g., daily, weekly, monthly, etc.) added and/or replaced. For example, an odor reducing/preventing composition may be included as part of a cartridge that may be inserted into a compartment or region of the case.

### Latching Mechanisms

Any of these apparatuses may include one or more controls (e.g., buttons, levers, sliders, etc.) for releasing and/or engaging a latch holding the cover portion of the case closed over the enclosed cavity of the case. In some cases a pair of independently actuatable controls may be used. Any of these cases may include a latch or lock (e.g., latching mechanism) that may include two or more controls that may be actuated to open, or to permit opening of, the cover portion of the case. For example, the case may include a latch or latches holding the cover of the case closed; the latch(es) may be released by pressing of two buttons, e.g., on the sides of the case, that disengage latches holding the cover closed. The use of two or more controls (e.g., buttons) may provide additional security to prevent accidental opening of the case, including when dropped. In some cases the latches may be one or more snap hooks configured allow the cover to open and expose the enclosed cavity in which the dental appliance may be stored.

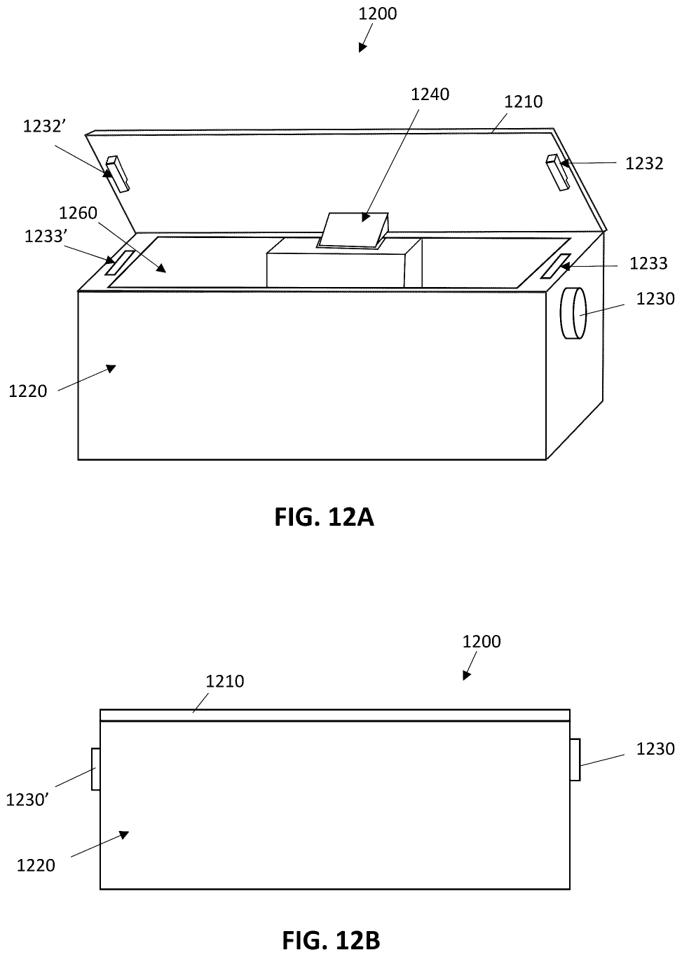

FIGS. 12A and 12B illustrate one example of a storage case 1200 including a cover (e.g., lid 1210) that encloses the cavity 1260 of the case that is configured to receive and hold the dental appliance. The example shown in FIGS. 12A-12B may be particularly well suited for use with one or more palatal expanders. For example, the central region of the enclosed cavity 1260 formed by the base 1220 may be un-obstructed and may be dimensioned to fit the palatal region of a palatal expander. In the example shown in FIGS. 12A-12B the base 1220 has a generally rectanguloid (e.g., rectangular cuboid) shape, having rounded edges. The lid 1210 forms the narrower upper surface of the device, and may open outwards, as shown. In FIGS. 12A-12B the lid is hinged 1240 on one long side.

In the example shown in FIGS. 12A-12B, the hinge region 1240 is biased to open the lid as shown, and to hold the lid open. The bias may be spring (e.g., a torsional spring). In a closed state, the bias (e.g., torsion spring) are held in compressed state by the pair of hook engagements 1232, 1232′ that each engage a latch 1233, 1233′ on the base 1230. The latches may be biased to engage with the hook. In some cases the latch may be a snap fit. In some cases when these snap fits disengage, the lid may open as the bias (e.g., torsion spring) de-compresses. In the example shown, each latch may be disengaged by a finger-actuated control, shown as a button 1230, 1230′ on each side of the case.

Any of these cases may include an attachment region for coupling to a fastener, such as a clip, tie (e.g., leash), chain, etc.

The example case shown in FIGS. 12A-12B has flat bottom so that it can stand up-right on table in a closed state. However, the case may be configured to sit on a major side, e.g., the back or front of the case, as well or instead. In general, the case shown in this example may be configured to contain, carry and/or store a dental appliance such as a palatal expander.

In use, the case may be opened by disengaging the latches on either sides of the device by pressing both of two buttons on each of two sides to disengage snap hooks 1232, 1232′ from the latch 1233, 1233′ and allow the lid to open and expose the enclosed storage space. The hinge may include a pair of torsion springs (e.g., a right torsional spring and a left torsional spring) that provide an opening force acting to drive the lid open unless latched closed. The torsional springs are supported by the base 1220 and to a pivot cam surface that is rigidly coupled (or integrally formed with) the lid. The pivot cam surface may be configured to rotate on or with a pin to open and close the lid. When the lid is in a closed state, the torsion springs may be in a compressed state. When the snap fit disengages, the stored force in the springs is released, and the pivot cam surface pivots relative to the base (e.g., by rotating on or with the pin) so that the top half pops open as the torsion spring de-compresses.

The latching mechanism of a case such as the one shown in FIGS. 12A-12B may include a latch that is slidably held in the wall of the base and is biased outwards, relative to the enclosed chamber of the case, by one or more biases (e.g., springs, show as coil springs in this example). A button 1230, 1230 may be coupled to each of the latches so that the user my push the latch in, e.g., towards the enclosed chamber of the case, to allow the latches to release the hooks 1232, 1232′ on the lid. Closing the lid will drive the hooks down and against a surface of each latch, displacing the latch until the hook is inserted into the base allowing the latch to drive against the narrow region of the hook to retain the lid in the closed configuration. The latches may engage with a hook that may be separately or integrally formed with the lid. The latch may be integrated with the button and may be slidably held in the base so that it may slide in/out relative to the base, e.g., on one or more posts that engage with channels on the latch. One or more biases (e.g., springs) may tend to drive the latch and button outwards, but may be overcome by pushing inwards on the buttons. The latch may also include a capture region that is configured to engage with the engagement (e.g., hook) from the lid.

It should be appreciated that all combinations of the foregoing concepts and additional concepts discussed in greater detail below (provided such concepts are not mutually inconsistent) are contemplated as being part of the inventive subject matter disclosed herein and may be used to achieve the benefits described herein.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached, or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

Throughout this specification and the claims which follow, unless the context requires otherwise, the word “comprise,” and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

In general, any of the apparatuses and methods described herein should be understood to be inclusive, but all or a sub-set of the components and/or steps may alternatively be exclusive, and may be expressed as “consisting of” or alternatively “consisting essentially of” the various components, steps, sub-components, or sub-steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The present disclosure includes the following numbered clauses.

Clause 1. A storage case for a dental appliance, the storage case comprising: a lid; a base having an open cavity configured to receive the dental appliance, wherein the base and the lid are operable to form an enclosed cavity between the lid and the base to enclose the dental appliance; and a hinge comprising one or more biases, wherein the one or more biases is configured to provide a first resistance to opening the lid from a closed position to a first transition position that is part way to a predetermined partially open position, further wherein the one or more biases is configured to apply a force to open the lid from the first transition position to the predetermined partially open position, further wherein the one or more biases is configured to provide a second resistance to opening the lid from the predetermined partially open position to a second transition position, and further wherein the one or more biases is configured to apply a force to opens the lid from the second transition position to a predetermined fully open position.

Clause 2. The storage case of clause 1, wherein the predetermined partially open position is between 25% and 55% of the angle between the closed position and the predetermined fully open position.

Clause 3. The storage case of any of clauses 1-2, wherein the predetermined partially open position is between 10-60 degrees relative to the closed position.

Clause 4. The storage case of any of clauses 1-3, wherein the predetermined fully open position is between 90-180 degrees relative to the closed position.

Clause 5. The storage case of any of clauses 1-4, wherein the first transition position is between about 40-60% of the angle between the closed position of the lid and the predetermined partially open position of the lid.

Clause 6. The storage case of any of clauses 1-5, wherein the second transition position is between about 40-60% of the angle between the predetermined partially open position of the lid and the predetermined fully open position of the lid.

Clause 7. The storage case of any of clauses 1-6, wherein the one or more biases comprises a cam.

Clause 8. The storage case of any of clauses 1-7, wherein the one or more biases comprises a spring configured to apply a force to the lid to hold the lid away from the base or closed against the base.

Clause 9. The storage case of clause 7, wherein the cam comprises a cam surface having a cam profile configured to receive the force from a spring to hold the lid away from the base in the predetermined partially open position, and/or to hold the lid away from the base in the predetermined and/or to hold the lid closed against the base.

Clause 10. The storage case of clause 9, wherein the cam profile is integrally formed with the lid.

Clause 11. The storage case of clause 9, wherein the spring comprises: a flat spring, a wire spring, or a combination thereof.

Clause 12. The storage case of clause 9, wherein the spring is configured to follow the cam profile.

Clause 13. The storage case of any of clauses 1-12, wherein the open cavity of the base includes a raised pattern configured to elevate the dental appliance away from a floor of the open cavity.

Clause 14. The storage case of any of clauses 1-13, wherein the base includes one or more drainage holes on a floor of the open cavity configured to allow liquids to drain from the storage case.

Clause 15. The storage case of any of clauses 1-14, further comprising a compartment in fluid communication with the open cavity configured to hold an odor reducing/preventing composition.

Clause 16. A storage case comprising: a lid; and a base having an open cavity configured to receive a dental appliance, wherein the base and the lid are operably coupled together at a hinge to form an enclosed cavity between the lid and the base to enclose the dental appliance, wherein the base includes one or more drainage holes on or adjacent to the hinge region that are configured to drain liquids from inside the base to outside the base, further wherein the based in configured so that the open cavity is titled towards the one or more drainage holes when the base is seated on a horizontal surface.

Clause 17. The storage case of clause 16, wherein the one or more drainage holes are concurrently disposed on a floor and a wall of the base.

Clause 18. The storage case of any of clauses 16-17, wherein the one or more drainage holes are disposed on a floor of the base.

Clause 19. The storage case of any of clauses 16-18, wherein the base includes one or more channels configured to collect and direct liquid toward the one or more drainage holes.

Clause 20. The storage case of clause 19, where the one or more channels are shaped in a wavy pattern.

Clause 21. The storage case of any of clauses 16-20, wherein the base includes one or more feet disposed on an outer surface of the base configured to tilt a floor of the base toward the one or more drain holes.

Clause 22. The storage case of any of clauses 16-21, wherein the lid and the base are formed from an injection molded plastic.

Clause 23. The storage case of clause 21, wherein the injected molded plastic includes Vesaflex-OM3060.

Clause 24. The storage case of any of clauses 16-23, wherein the base includes a liner formed from a hydrophobic material.

Clause 25. The storage case of any of clauses 16-24, wherein the case further comprises a reservoir configured to collect fluids from the one or more drainage holes.

Clause 26. The storage case of any of clauses 16-25, further comprising a compartment in fluid communication with the open cavity configured to hold an odor reducing/preventing composition.

Clause 27. A storage case comprising: a lid comprising: a first housing section; sides extending from an outer perimeter of the first housing section; and a first portion of a separable threaded joint centrally disposed of the first housing section; and a base comprising: a second housing section; sides extending from an outer perimeter of the second housing section; and a second portion of the separable threaded joint centrally disposed on the second housing, wherein the lid and the base are configured to couple together by the separable threaded joint to form an enclosed cavity to hold one or more dental appliances.

Clause 28. The storage case of clause 27, wherein the enclosed cavity if formed of only the lid and the base.

Clause 29. The storage case of any of clauses 27-28, wherein the first portion of the separable threaded joint includes an opening configured to receive a shaft of the second portion of the separable threaded joint.

Clause 30. The storage case of clause 29, wherein the opening includes a flared section larger than the shaft.

Clause 31. The storage case of clause 29, wherein the shaft includes a tapered section narrower than the opening.

Clause 32. The storage case of any of clauses 27-31, wherein the base includes one or more drainage holes.

Clause 33. The storage case of any of clauses 27-32, wherein the base includes one or more finger grips.

Clause 34. The storage case of any of clauses 27-33, wherein the lid and the base are recyclable.

Clause 35. The storage case of any of clauses 27-34, wherein the lid and the base are polyethylene terephthalate.

Clause 36. The storage case of any of clauses 27-35, wherein the separable threaded joint is configured to releasably lock the lid and the base together to form the enclosed cavity.

Clause 37. The storage case of any of clauses 27-36, further comprising a compartment in fluid communication with the enclosed cavity configured to hold an odor reducing/preventing composition.

Clause 38. A storage case comprising: a hollow cylindrical portion configured to form an open cavity, the hollow cylindrical portion comprising: a base portion with curved sides surrounding a first inner surface; and an upper portion with curved sides at least partially surrounding a second inner surface, wherein the curved sides of the upper portion are coupled to the curved sides of the base portion, forming the cavity, wherein the upper portion includes an opening configured to provide access to the open cavity; a lid rotatably coupled to the hollow cylindrical portion and configured to rotate over the upper portion to selectively cover the opening in the open cavity and form an enclosed cavity configured to fully receive at least one dental appliance; and a resistive engagement between the lid and the hollow cylindrical portion.

Clause 39. The storage case of clause 38, wherein the resistive engagement comprises a magnetic engagement.

Clause 40. The storage case of any of clauses 38-39, further comprising a snap-fit rotating joint configured to rotatably couple the lid to the hollow cylindrical portion.

Clause 41. The storage case of any of clauses 38-40, wherein the resistive engagement is configured to provide tactile feedback on the position of the lid relative to the hollow cylindrical portion.

Clause 42. The storage case of any of clauses 38-41, wherein the resistive engagement is configured to: hold the lid in a position to uncover the opening in the upper portion of the hollow cylindrical portion; and hold the lid in a position to cover the opening in the upper portion of the hollow cylindrical portion.

Clause 43. The storage case of any of clauses 38-42, wherein the resistive engagement comprises at least one magnet disposed near the curved sides of the upper portion, the magnet configured to: hold the lid in a position to uncover the opening in the upper portion of the hollow cylindrical portion; and hold the lid in a position to cover the opening in the upper portion of the hollow cylindrical portion.

Clause 44. The storage case of any of clauses 38-43, wherein the hollow cylindrical portion includes at least one drainage hole.

Clause 45. The storage case of any of clauses 38-44, further comprising a compartment in fluid communication with the open cavity configured to hold an odor reducing/preventing composition.

Clause 46. A storage case for a dental appliance, the storage case comprising: a lid; a base having an open cavity configured to receive the dental appliance, wherein the base and the lid are operable to form an enclosed cavity between the lid and the base to enclose the dental appliance; a hinge comprising one or more biases configured to open the lid; a first releasable latch configured to secure the lid to the base; a second releasable latch configured to secure the lid to the base; a first user-actuated control configured to release the first releasable latch; and a second user-actuated control configured to release the second releasable latch, wherein the lid is configured to remain closed until both the first and second user-actuated controls are actuated.

Clause 47. The storage case of clause 46, wherein the base is configured to hold a palatal expander within the open cavity.

Clause 48. The storage case of any of clauses 46-47, wherein the storage case has a rectangular cuboid shape when the lid is closed.

Clause 49. The storage case of any of clauses 46-48, further comprising an attachment region for coupling to a fastener.

Clause 50. The storage case of any of clauses 46-49, further comprising a compartment in fluid communication with the open cavity configured to hold an odor reducing/preventing composition.

What is claimed is:

1. A storage case for a dental appliance, the storage case comprising:
a lid;
a base having an open cavity configured to receive the dental appliance, wherein the base and the lid are operable to form an enclosed cavity between the lid and the base to enclose the dental appliance; and
a hinge comprising one or more biases, wherein the one or more biases is configured to provide a first resistance to opening the lid from a closed position to a first transition position that is part way to a predetermined partially open position, further wherein the one or more biases is configured to apply a force to open the lid from the first transition position to the predetermined partially open position, further wherein the one or more biases is configured to provide a second resistance to opening the lid from the predetermined partially open position to a second transition position, and further wherein the one or more biases is configured to apply a force to opens the lid from the second transition position to a predetermined fully open position.

2. The storage case of claim 1, wherein the predetermined partially open position is between 25% and 55% of the angle between the closed position and the predetermined fully open position.

3. The storage case of claim 1, wherein the predetermined partially open position is between 10-60 degrees relative to the closed position.

4. The storage case of claim 1, wherein the predetermined fully open position is between 90-180 degrees relative to the closed position.

5. The storage case of claim 1, wherein the first transition position is between about 40-60% of the angle between the closed position of the lid and the predetermined partially open position of the lid.

6. The storage case of claim 1, wherein the second transition position is between about 40-60% of the angle between the predetermined partially open position of the lid and the predetermined fully open position of the lid.

7. The storage case of claim 1, wherein the one or more biases comprises a cam.

8. The storage case of claim 1, wherein the one or more biases comprises a spring configured to apply a force to the lid to hold the lid away from the base or closed against the base.

9. The storage case of claim 7, wherein the cam comprises a cam surface having a cam profile configured to receive the force from a spring to hold the lid away from the base in the predetermined partially open position, and/or to hold the lid away from the base in the predetermined fully open configuration, and/or to hold the lid closed against the base.

10. The storage case of claim 9, wherein the cam profile is integrally formed with the lid.

11. The storage case of claim 9, wherein the spring is configured to follow the cam profile.

12. The storage case of claim 1 wherein the open cavity of the base includes a raised pattern configured to elevate the dental appliance away from a floor of the open cavity.

13. The storage case of claim 1, wherein the base includes one or more drainage holes on a floor of the open cavity configured to allow liquids to drain from the storage case.

14. The storage case of claim 1, further comprising a compartment in fluid communication with the open cavity configured to hold an odor reducing/preventing composition.

15. A method, the method comprising:
opening a lid of a dental appliance storage device from a closed position to a first transition position that is part way to a predetermined partially open position by applying a bias force to overcome a first resistance to opening;
applying, by one or more biases in a hinge region of the dental appliance storage device, a first opening force to open the lid from the first transition position to the predetermined partially open position;
opening the lid from the predetermined partially open position to a second transition position that is part way to a predetermined open position by applying a bias force to overcome a second resistance to opening; and
applying, by the one or more biases in the hinge region of the dental appliance storage device, a second opening force to open the lid from the second transition position to the predetermined open position.

16. The method of claim 15, wherein the predetermined partially open position is between 25% and 55% of the angle between the closed position and the predetermined open position.

17. The method of claim 15, wherein the predetermined open position is between 90-180 degrees relative to the closed position.

18. The method of claim 15, wherein the one or more biases comprises a cam.

19. The method of claim 18, wherein the cam comprises a cam surface having a cam profile configured to receive force from a spring to hold the lid away from the base in the predetermined partially open position, and/or to hold the lid away from the base in the predetermined open position and/or to hold the lid closed against the base.

20. A storage case comprising:
a lid; and
a base having an open cavity configured to receive a dental appliance, wherein the base and the lid are operably coupled together at a hinge to form an enclosed cavity between the lid and the base to enclose the dental appliance,
wherein the base includes one or more drainage holes on or adjacent to the hinge region that are configured to drain liquids from inside the base to outside the base, further wherein the based in configured so that the open cavity is titled towards the one or more drainage holes when the base is seated on a horizontal surface.
